(19) United States
(12) Patent Application Publication
(10) Pub. No.: US 2002/0147701 A1
(43) Pub. Date: Oct. 10, 2002

(54) System and method for registering or searching in multiple human resource hosts

(76) Inventor: Lan Chang, Taipei (TW)

Correspondence Address: RABIN & CHAMPAGNE, PC, 1101 14TH STREET, NW, SUITE 500, WASHINGTON, DC, 20005, US

(21) Appl. No.: 09/983,498

(22) Filed: Oct. 24, 2001

Related U.S. Application Data
(60) Provisional application No. 60/242,718, filed on Oct. 25, 2000.

(51) Int. Cl. G06F 7/00

(52) U.S. Cl. 707/1

(57) ABSTRACT

A method for searching in multiple human resource hosts via a computer. Wherein the computer comprises a user interface (UI) for accessing a search condition. The method firstly begins with inputting the search conditions on the UI. Next, the search conditions are transmitted to the human resource hosts with each of the human resource hosts' data format retrieved from a server data format database in the computer. After that, each human resource host retrieves a search result according to the search conditions, and then posts the search result to the computer. Then the search result is stored in a found profile database of the computer and displayed in UI. The method enables a user to register and search the suitable job seekers or position-vacant companies simultaneously in the multiple human resource hosts, instead of repeatedly inputting processes in different hosts.

This application incorporates by reference Provisional application Serial No. 60/242,718, Filed on Oct. 25, 2000.

### BACKGROUND OF THE INVENTION

1. Field of the Invention

This invention is a system and method which relates to register or search in a human resource host, and more particularly to register or search in multiple human resource hosts.

2. Description of the Related Art

In the past, if people want to find a job, they would mostly know the opportunity from the advertisement on newspaper and magazines, job classification, or the introduction of relatives and friends. Then they would contact that company by letters or telephones to arrange the time for interview. However, by the fast growing application of computers and network, the employment wanted can quickly and conveniently find the working opportunities through the network. For example, by connecting with the websites of companies, enterprises or the special web sites which offer the information of employment, people who are looking for a job can obtain the basic information and requirements of employment agencies. The websites which offer the information of employment are called the website of human resource. After finding a suitable employment agency, one can normally email personal C.V. first, and then arrange the time for interview. Comparing with the way to find an employment or an employee before, it is more effective and faster to proceed through the network. Similarly, the company with an employment vacancy can search the right employee through a human resource website.

Generally speaking, a human resource website includes a web server and a personal profile database. The web server provides users those who want to find a job or an employee for registration and search services. Users can register required data and search related employment opportunities or suitable recruits. And the personal profile database is for storing the registered basic data of the employment or job seekers, and the search conditions. The web server can connect with the personal profile database, and then store and fetch the data inside.

This web server can offer user terminal the interface of the hypertext transmission protocol (HTTP). Normally a user terminal uses a browser to connect to the web server of a human resource website and to register basic data. Then the user becomes a member of the human resource website. Besides, the job seekers can also input some searching conditions for those position-vacancy companies which match the conditions. After the web server searched in the personal profile database, the data of those suitable companies will be send to the browser to display for the user or sent to the user by an email. The above-mentioned example is on the side of the job seeker. Position-vacancy companies can use the same way to find suitable employees. Meanwhile, there is another type of human resource host, which can provide direct access to database through network. It can provide different types of HTTP for users to link. Its function is similar to the above-mentioned human resource website. Even though, the above-mentioned human resource hosts provide many convenient and fast functions. There are still some disadvantages described as following.

1. Narrow range for searching:

A user can only search data in the human resource website which the user has connected with. The data in other human resource websites cannot be searched by the user at the same time.

2. Inefficient way of contact

When finding the suitable person or vacancy through the human resource websites or hosts, users can only use email to ask further inquiry or contact if there is no contact phone. And users can do nothing but waiting if there is no reply. It is not easy to manage the result of contact efficiently.

3. Repeated process of registration

To register in multiple human resource websites or hosts, users have to input basic data in every website one by one. Therefore, users must repeatedly input the same data, but the process of registration in multiple human resource websites or hosts cannot be simplified.

4. Need to adapt to different interfaces of human resource websites or hosts.

Because user interfaces of different human resource websites or hosts are not the same, users have to learn to adapt themselves to those different operating process, the logical language of searching conditions and so on. Thereby, it becomes a burden on users.

5. Repeated process of search

Users always have to search the suitable persons or vacancies in multiple human resource websites or hosts. However, users have to repeatedly input the searching conditions in each website or host. Furthermore, the results of search in different human resource websites or hosts cannot be joined up together.

6. Incapability of contact immediately

When users find the suitable persons or vacancies, they cannot proceed on-line communication to inquire further situations or conditions of the matched ones and the time for interview.

7. When users find the suitable persons or vacancies, they usually cannot send the same email to several people at the same time. Users have to send one by one manually.

8. Normal human resource websites or hosts do not provide the system or function of interview request or response.

### SUMMARY OF THE INVENTION

It is therefore an object of the invention to provide a system and a method for registering or searching in multiple human resource websites or hosts. The system and the method enable users to do only one-time input to register or search in multiple human resource websites or hosts. The repeated inputting process of registering basic data and searching conditions is decreased. In addition, the invention provides the function of on-line immediate communication to efficiently proceed further inquiry or contact.

According to the objects of the invention, a system for searching in multiple human resource hosts simultaneously is proposed. The human resource hosts in this system enable the job seekers to search the position vacancies or the position vacant companies to search job seekers. The system comprises a first user interface (UI), server data format database, a search poster, a search result analyzer, and a found profile database. The first UI enables users to control the system. The server data format database is for storing the data format of search and registration of human resource hosts. The search poster is for transmitting search conditions to every human resource host. The search result analyzer is for receiving and analyzing search results from the human resource hosts. The found profile database is for storing search results. Wherein, after the user inputs the search conditions via the first UI, the search poster transmits the search conditions to the human resource hosts. After receiving the search conditions, the hosts retrieve the search results and then transmit the search results to the search result analyzer. And the search results are displayed in the first UI and are stored in the found profile database.

The system can be installed in a user terminal. The system further comprises a direct channel and an on-line search unit. The direct channel is installed in a human resource host for providing a direct connection to access the personal profile database of a human resource host, to receive search conditions from a search poster, to retrieve the search results from the personal profile database according to search conditions, and to transmit the search results to the user terminal. The on-line search unit is for being installed in the user terminal for the user to input an on-line search condition, to search an on-line job seeker, and to provide on-line contact with the one-line user. The on-line search unit comprises a TSR (terminate-and-stay-resident) and an on-line messenger module. The TSR is a process residing in an operation system (OS) of the user terminal and is for connecting to the personal profile database via the direct channel. The on-line messenger module is for building on-line contact with the on-line user. Wherein, after the user inputs the on-line search conditions via the first UI, the TSR transmits the on-line search conditions to the direct channel. The direct channel retrieves an on-line search result from the personal profile database and transmits the on-line search result to TSR. Then the on-line messenger module is triggered to build the on-line contact with the on-line users of the on-line search result.

In addition, the system can also be installed in a server and the user uses a user terminal to connect with the serve. To achieve the above-identified objects, the invention further provides a system for registering in multiple human resource hosts. Wherein, the human resource hosts allow the job seekers or the position vacant companies to register, and save the user profile in the profile database. The system comprises a user interface (UI), a server data format database, a profile poster, and a user profile database. The UI is for a user to control the system, and the server data format database is for storing data format of registration of the human resource hosts. The profile poster is for transmitting a user profile inputted via the UI to the human resource hosts with each transmitting user profile data format of the human resource hosts, which is retrieved from the server data format database. The user profile database is for storing the user profile. Wherein, after the user inputs the user profile via the UI, the profile poster saves the user profile to the user profile database, and transmits the user profile to each human resource host. Then the human resource hosts receive and store the user profile.

The invention achieves the above-identified objects by further providing another method for registering in multiple human resource hosts by being installed in a computer to access a user profile. Firstly the method begins with inputting or modifying the user profile in the computer. Then, the user profile is stored in a user profile database in the computer and is transmitted to the human resource hosts with each of the human resource hosts' data format retrieved from a server data format database in the computer. method for searching in multiple human resource hosts via a computer. Wherein the computer comprises a user interface (UI) for accessing a search condition. The method firstly begins with inputting the search conditions on the UI. Next, the search conditions are transmitted to the human resource hosts with each of the human resource hosts' transmitting data format retrieved from a server data format database in the computer. After that, each human resource host retrieves a search result according to the search conditions, and then posts the search result to the computer. Then the search result is stored in a found profile database of the computer and displayed in UI.

### BRIEF DESCRIPTION OF THE DRAWINGS

Other objects, features, and advantages of the invention will become apparent from the following detailed description of the preferred but non-limiting embodiments. The description is made with reference to the accompanying drawings, in which:

FIG. 1 is a network computer system block diagram of a system of registering and searching in multiple human resource websites according to the preferred embodiment of the invention.

FIG. 2 is a system block diagram of the search software in the computer of FIG. 1.

FIG. 3 is a flowchart of the method for registering to multiple human resource websites.

FIG. 4 is a flowchart of the method for searching matched job seekers of multiple human resource websites for the system of registering and searching in multiple human resource websites according to the preferred embodiment of the invention.

FIG. 5 is a flowchart of the method for refining for the system of registering and searching in multiple human resource websites according to the preferred embodiment of the invention.

FIG. 6 is a block diagram of the on-line search unit in FIG. 2

FIG. 7 is a flowchart of the method for on-line search for the system of registering and searching in multiple human resource websites according to the preferred embodiment of the invention.

FIG. 8 is a structural block diagram of the on-line messenger module in FIG. 6.

FIG. 9 is a structural block diagram of the email-analyzing module in FIG. 2.

FIG. 10 is a flowchart of the method for checking emails for the system of registering and searching in multiple human resource websites according to the preferred embodiment of the invention.

FIG. 11 is a flowchart of the method for arranging an interview time for the system of registering and searching in multiple human resource websites according to the preferred embodiment of the invention.

FIG. 12 is a computer network block diagram of servers in the system of registering and searching in multiple human resource websites according to the preferred embodiment of the invention.

FIG. 13 is a system block diagram of the search engine in FIG. 12.

FIG. 14 is a structural block diagram of the first on-line search method.

FIG. 15 is a flowchart of the method for on-line search for the system of registering and searching in multiple human resource websites according to the preferred embodiment of the invention.

FIG. 16 is a structural block diagram of the second on-line searching method for the system of registering and searching in multiple human resource websites according to the preferred embodiment of the invention.

FIG. 17 is a structural block diagram of the email-checking module in FIG. 13.

### DESCRIPTION OF THE PREFERRED EMBODIMENT

The system and method of this invention provide a user to be able to register and search job seeker or position vacant companies in multiple human resource websites. Besides, the user can proceed to further on line communication or contact. In the description of the preferred embodiment, the human resource website is an example, but the invention is not limited by that example.

### EXAMPLE ONE

The system of registering and searching in multiple human resource websites in this invention is installed in the user's computer system. The user can link to the multiple human resource websites via network and furthermore register as a member or search suitable job seekers or position vacant companies. Take an example of “A position vacant company, C, wants to search a suitable job seeker” as a description in this preferred embodiment. Suppose U, a user, is an employee in the personal department of a position vacant company C, who is responsible for finding a suitable person via the system of this invention.

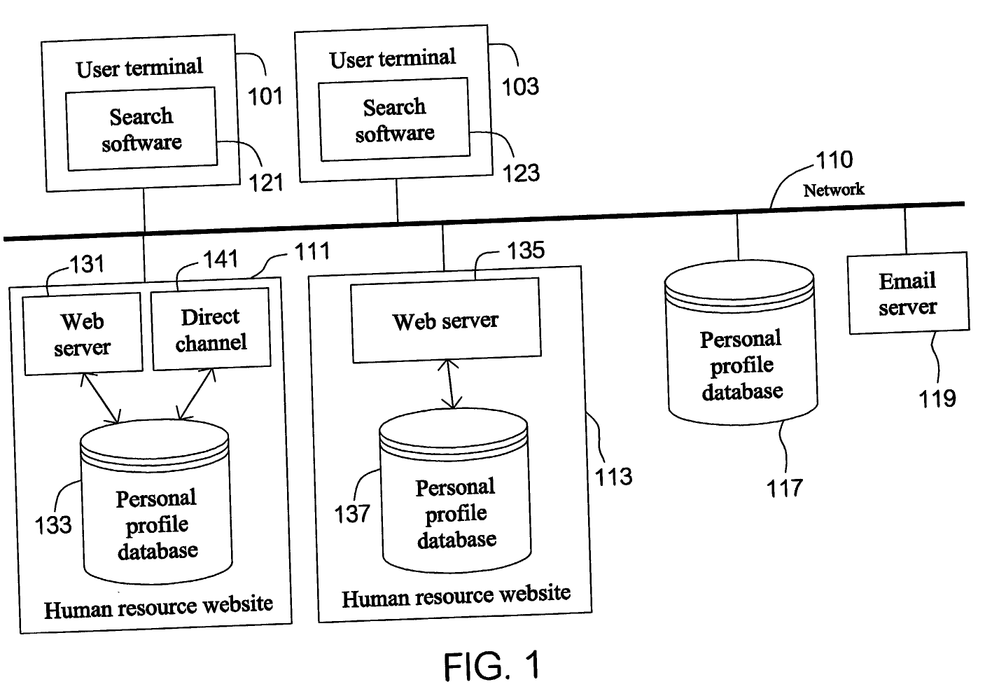

Referring to FIG. 1, it shows the network computer block diagram of a system of registering and searching in multiple human resource websites according to the preferred embodiment of the invention. In FIG. 1, a human resource website 111 and website 113 can offer users the services of registration and search. The website 111 includes a web server 131 and a personal profile database 133. The website 113 includes a web server 135, and a personal profile database 137. The web server 131 and the web server 133 can offer the user the services of registration and searching suitable job seekers. The registration database 133 and 137 are used to store user profiles of company and user profiles of job seeker. The user profiles of company, including many data columns such as website account, company name, responsible name, contact name, year of company, company profile, address, contact number, email address, capital, required conditions of a newcomer, and job responsibilities an so on, can be the basic data of position vacant companies. The user profiles of job seeker, including many data columns such as website account, name, age, biography, address, contact number, email address, gender, interest, religion, education, experience, required wage, and required job position, and so on, can be the basic data of job seekers.

Besides, the website 111 furthermore includes a direct channel 141. It can offer an interface for direct access to the personal profile database 133. It does not need to convert the format of hypertext transmission protocol, HTTP due to the direct channel 141. Therefore, it can offer faster access channel.

In FIG. 1, a user 101 and 103 connect to the website 111 and website 113 via a network 110. Furthermore, the system of this invention includes a search software 121, which is installed in the user 101. The search software 121 is for providing the user, U, with registering or searching a suitable job seeker in the multiple human resource website.

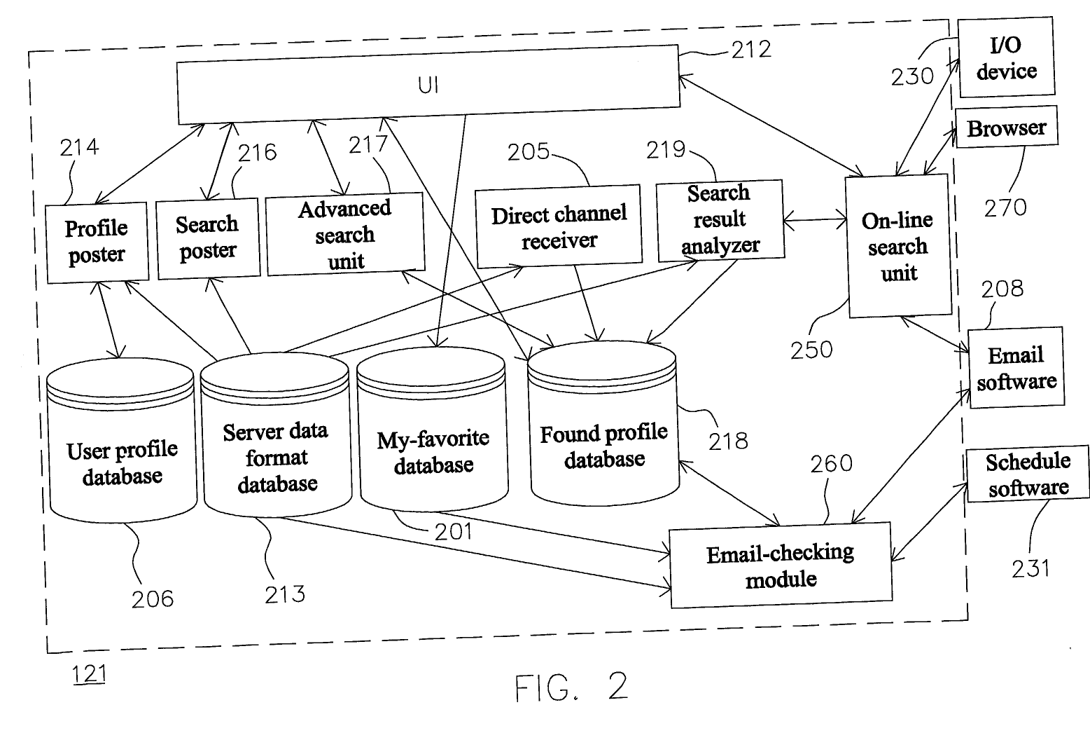

Referring to FIG. 2, it illustrates the system block diagram of the search software 121 in FIG. 1. In FIG. 2, a user interface (UI) 212 is for the user to control the system. And the UI 212 can be a graphical user interface (GUI). A profile poster 214 is for providing the user to transmit the user profile to the human resource website 111 and website 113 in order to register or modify user profiles. The user profile database 206 is for storing user profiles of the user, U. The search poster 216 provides the user, U with searching suitable job seekers in multiple human resource websites and a advanced search unit 217 can further be used to find advanced search results by the search conditions which are set by the user, U.

A direct channel receiver 205 is for receiving search results from a direct channel in a human resource website (for example, the direct channel 141 in the human resource website 111). A search result analyzer 219 is for receiving the search result from a web server in a human resource web site (for example, the web server 135 in the human resource website 113). And the format of search results can be the hypertext markup language (HTML), extensible markup language (XML), or other homepage languages. A found profiles database 218 is for storing the search results via the search poster 216 or the advanced search unit 217. The result, which is searched by the user, is the user profile of the job seeker.

A my-favorite database 201 is for the user U to selectively store the job seeker's user profile of the search results. Wherein, users can define many different kinds of folders, such as interviewed, ready to interview, registered, not registered, qualified, and so on. A server data format database 213 is for storing data format of registration and search of each human resource website. And the server data format database 213 provides corresponding data format of every human resource website for the profile poster 214, the search poster 216, the direct channel receiver 205 and the search result analyzer 219. So, the server data format database 213 has to be regularly updated when there sets up a new human resource website or any website changes its registration or search data format.

In addition, the search software 121 even includes an on-line search unit 250 and an email-checking module 260. An on-line search unit is for searching an on-line job seeker and further providing a user on-line contact to the on-line suitable job seeker. The email-checking module 260 is for checking and analyzing new emails received by an email software 208.

Thereby, a request is supposed that the user U uses the user terminal 101 to link to a human resource website in order to search a job seeker.

Registration or Modification of User Profile:

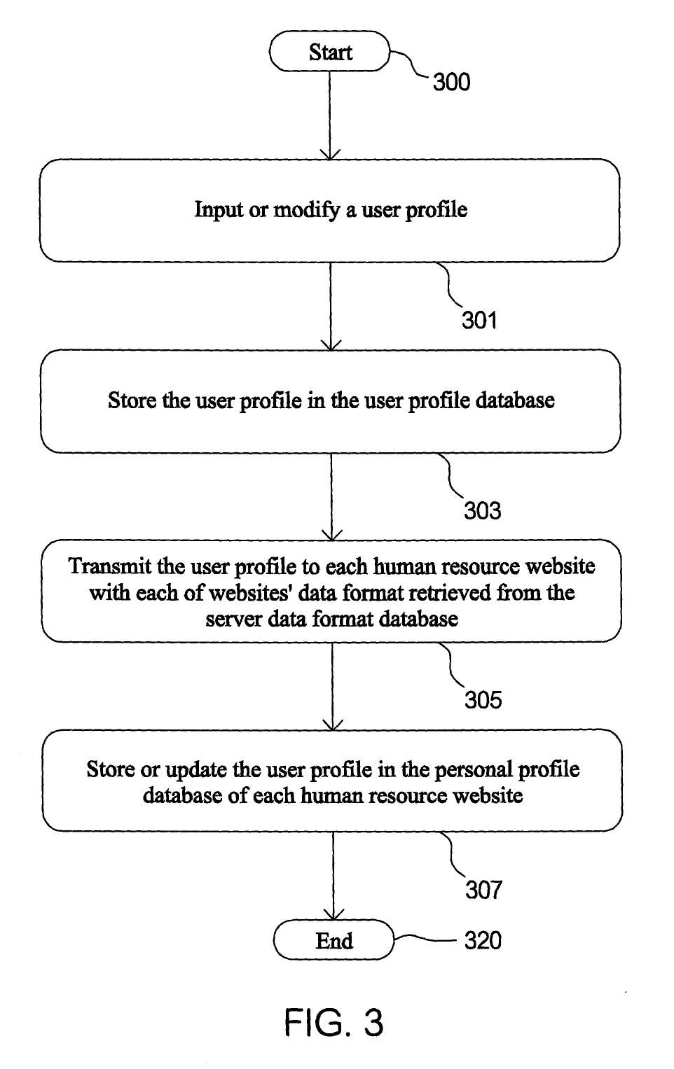

Please refer FIG. 3 at the same time. FIG. 3 illustrates the flowchart of the method for registering to multiple human resource websites. Firstly, at the step 301, the user U inputs or modifies a user profile on the UI 212. The user profile for the user U is the company profile of the company C. The next step is the step 303. At the step 303, the profile poster 214 stores the user profile in the user profile database 206 and the next step is the step 305.

At the step 305, the profile poster 214 retrieves the registration data formats of the human resource website 111 and 113 via the server data format database 213, and transmit the corresponding website data format of user profile to the website 111 -and 113 in order to register. At this step, the user U can transmit the user profile to register in multiple human resource websites. Wherein, their data format could be the format of HTML. And the profile poster 214 can further let the user U to select human resource websites, which U would like to register.

Then, at the step 307, the web server 135 and the direct channel 141 receive the user profile and stores or modify in the personal profile database 133 and 137 in order to finish the request of registering or modifying the user profile from the user U to the website 111 and 113. When the request of registration from the user U to the website 111 or 113 has been done, the use U therefore becomes a member.

Searching a Job Seeker:

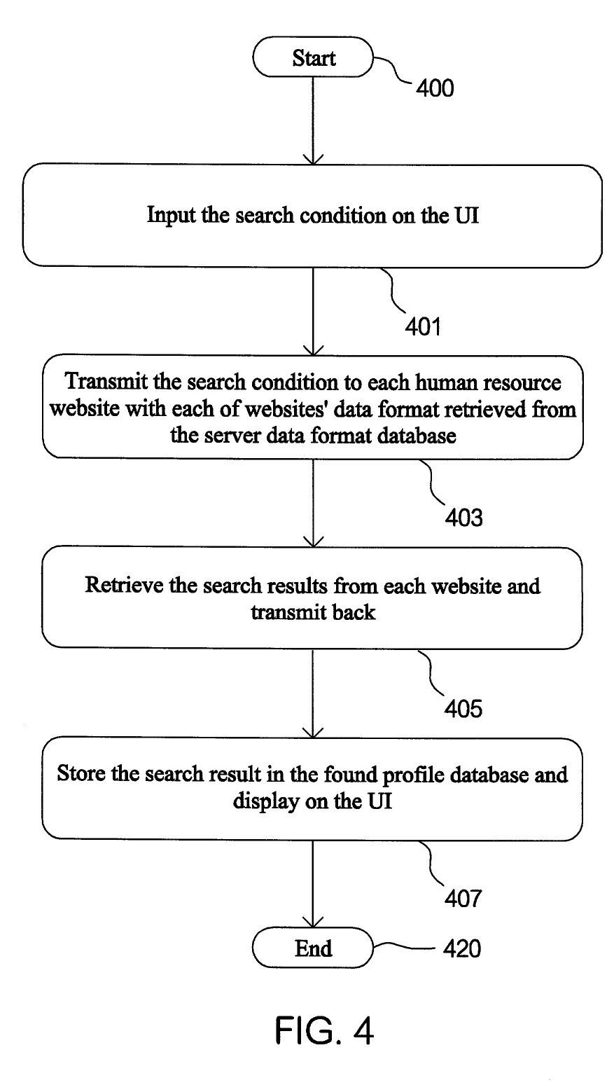

Referring to FIG. 4, it shows the flowchart of the method for searching job seekers of multiple human resource websites. Firstly at the step 401, the user U inputs search conditions on the UI 212 in order to search job seekers suitable for the search conditions. The search conditions could be range of ages, gender, position, working place, educational background, work experience, wages and so on. The user U can also sort the search results according to a parameter. The parameter could be a parameter of salary or wages a job seeker wants, how far from home, educational background, and work experience. The parameter would be salary/wages, or place if it is the condition that a job seeker wants to search a position vacant company. Next, the method proceeds to the step 403.

At the step 403, the search poster 216 transmits the search conditions to the human resource website 111 and website 113 with each of websites' data format. And each websites' data format can be retrieved from the server data format database 213. At this step, the search poster 216 can post the search conditions to multiple websites once in order to proceed searching. Wherein, each websites' data format could be the format of HTTP. Meanwhile, the search poster 216 can even let user U to select any human resource websites U wants.

Then the method proceeds to the step 405. At the step 405, the direct channel 141 and web server 135 receive the search conditions and retrieve search results from the personal profile database 133 and personal profile database 137 according to the search conditions. So the search results include a collection of user profiles of job seekers who are matched the search conditions in the human resource website 111 and website 113. And the search results are transmitted to the user terminal 101. Then proceed to the step 407.

At the step 407, the direct channel receiver 205 and the search result analyzer 219 receive and store the search results in the found profiles database 218 and display the search results on the UI 212. In this step, the direct channel receiver 205 is for receiving the search results from the direct channel 141. And the search result analyzer 219 is for receiving the search results from the web server 135.

Besides, user U can selectively store the job seekers of the search results into the my-favorite database 201. The data of job seekers can be deleted or retained in the search result database according to user's definition. User U can furthermore send emails of request of interview to the searched job seekers in order to invite job seekers to have interviews.

Advanced Searching:

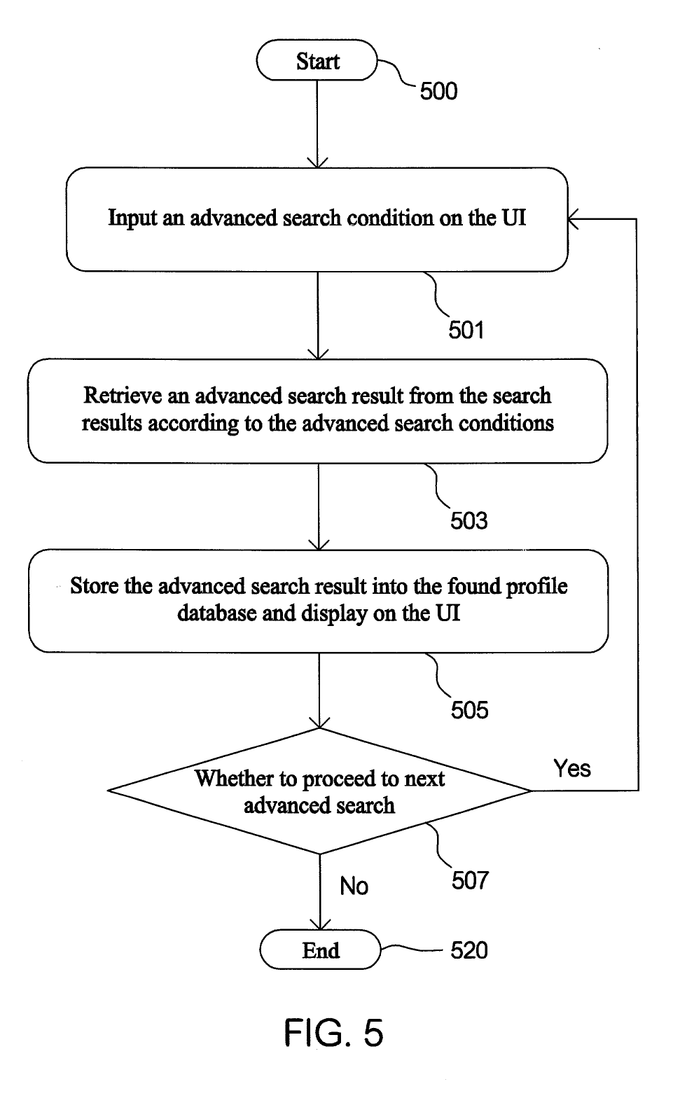

The advanced searching method can be applied to further advanced search in order to reset the domain of searching conditions to find more suitable job seekers. Please refer to FIG. 5. FIG. 5 illustrates the flowchart of the method for advanced searching. Firstly at the step 501, user U inputs advanced search conditions on the UI 212. Next, proceed to the step 503.

At the step 503, the advanced search unit 217 refines the search results according to the advanced search conditions and retrieves refining results. Then proceed to the step 505.

At the step 505, the advanced search unit 217 restores the advanced search results in the found profile database 218 and displays on the UI 212. Then proceed to the step 507.

At the step 507, the advanced search unit 217 asks user U whether to proceed to next advanced search. If yes, the method proceeds to the step 501. If not, the method ends.

In this method, user U has the search results or the content in the found profile database 218 in each human resource website to proceed advanced search

In addition, user U can selectively store the job seekers of search results in the my-favorite database 201. That is, the data of job seekers can be selectively removed or kept in the found profile database according to the setting of user U.

On-line Searching:

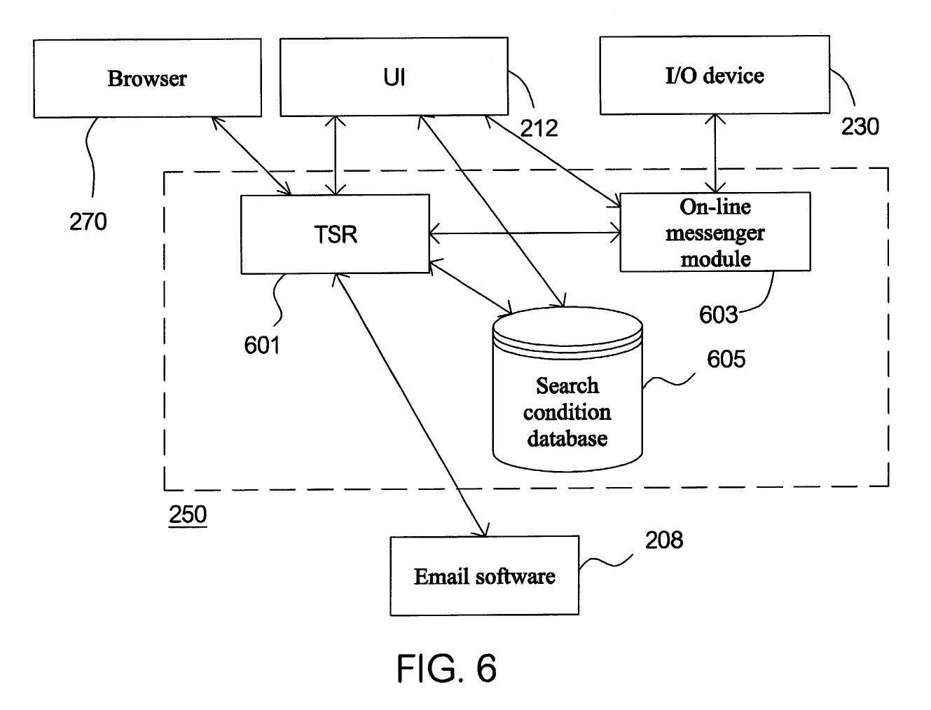

In FIG. 2, the system for registering or searching in multiple human resource websites even includes the on-line search unit 250. The on-line search unit 250 is for searching a job seeker who is on-line at the same time from a human resource web site and providing the function of on-line contact to proceed advanced on-line contact with this job seeker. Please simultaneously refer to FIG. 6. FIG. 6shows the structural block diagram of the on-line search unit 250 in FIG. 2. The on-line search unit 250 includes a TSR (terminate-and- stay-resident) 601, an on-line messenger module 603 and a search condition database 605. The TSR 601 is for connecting to the direct channel 141 of a human resource web site in order to access the personal profile database 133 via the network 110. The TSR 601 is a process of an operating system and always resides in the operation system (OS) of the user terminal 101. The OS could be Microsoft Windows systems, OS2, Linux, Unix, and so on. The search condition database 605 is for storing on-line search conditions. And the on-line messenger module 603 is for building a network connection with an on-line job seeker in order to proceed on-line communication.

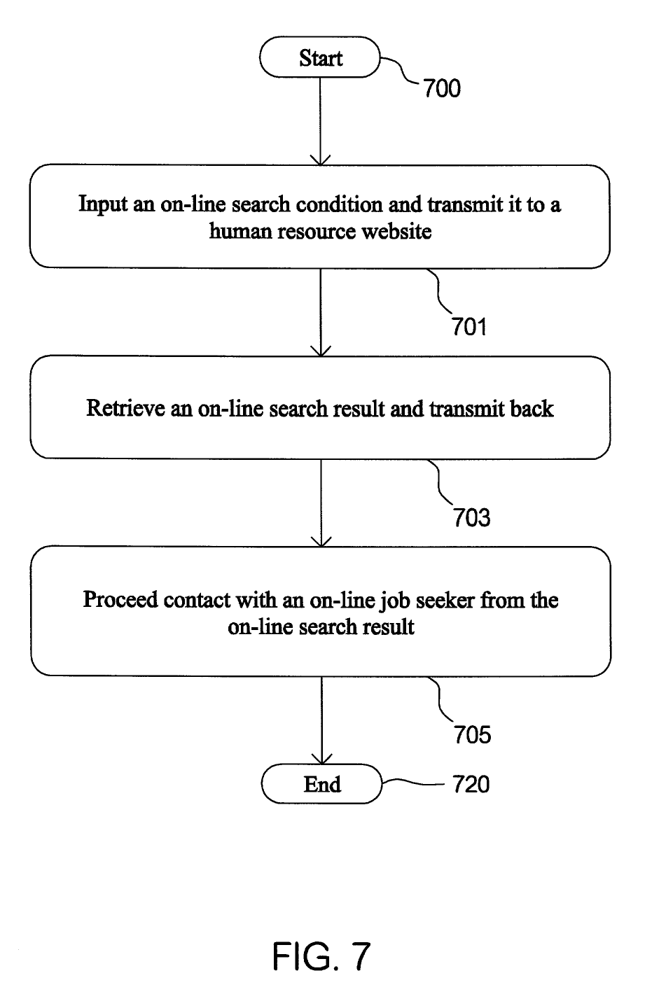

Please refer to FIG. 7 in the meantime. FIG. 7 illustrates the flowchart of the method for on-line search. Firstly, at the step 701, user U inputs on-line search conditions for looking for a job seeker who is on line at the same time and transmits the on-line search conditions to the human resource website 111. Wherein, user U can input the on-line search conditions through the UI 212 or TSR 601. Besides, the on-line search conditions can be stored in the search conditions database 605.

Next, at the step 703, the direct channel 141 receives the on-line search conditions and retrieves an on-line search result from the personal profile database 133. The on line search result can include an on-line job seeker, and the job seeker's internet protocol (IP) address. And the job seeker allows other to proceed on-line contact with each other. And the on-line search result is transmitted to the TSR 601 and displayed on the UI 212.

Then, at the step 705, the user U proceeds an on-line contact with an on-line job seeker of the on-line search result by the on-line messenger module 603. The on-line job seeker is supposed to be a job seeker S. Please refer to FIG. 2. The job seeker S who is using a search software 123 to connect to the human resource website 111 in a user terminal computer 103. The user U can select of-line or on-line to contact the job seeker S. If user U chooses the method of off-line contact, the TSR 601 will trigger an email software 208 to serve user U. The email software 208 could be the software of Microsoft Outlook, Netscape Messenger or Qualcomm Eudora, and so on. If user U chooses the method of on-line contact, the TSR 601 will trigger the on-line messenger module 603 to build a network connection to an on-line messenger module (not shown in FIG. 6) of the search software 123 of the user terminal 103.

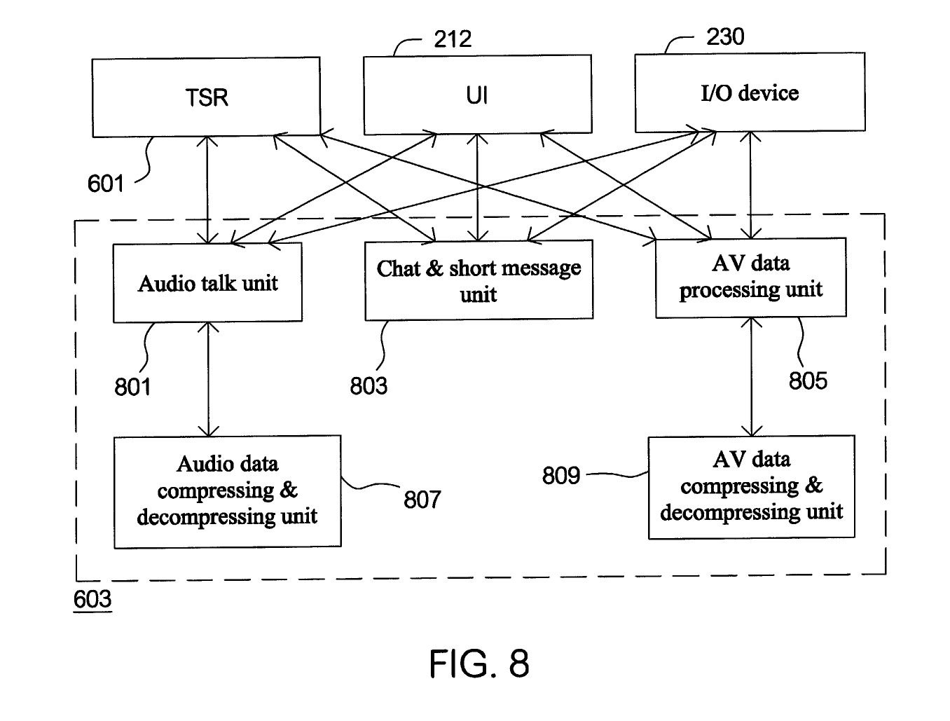

Please refer to FIG. 8 at the same time. FIG. 8 shows the structural block diagram of the on-line messenger module 603 in FIG. 6. The on-line messenger module 603 includes an audio talk unit 801, audio data compressing /decompressing unit 807, a chat & short message unit 803, and an audio & video data compress/decompressing unit 809. The user U can choose one of the following five ways to have advanced contact with the job seeker S.

(1) Audio talking:

The user U can direct talk to the job seeker S by a microphone of an I/O device 230. Firstly, the TSR 601 triggers the audio talk unit 801 to set up a network connect according to the IP address of the job seeker S and the audio talk unit (not shown in the figure) of the search software 123 of the user terminal 103. And the audio talk unit 801 receives the sound data from the microphone and transmits the sound data to the audio data compressing/decompressing unit 807 in order to compress and convert the sound data to network transferable data. Then the audio data compressing/decompressing unit 807 transmits the network transferable data to the audio data compressing/decompressing unit (not shown in the figure) in order to convert and decompress into audio data and transmits to the audio talk unit (not shown in the figure) of the search software 123 to play the audio data via the speaker of the user terminal 103. By the same way, the job seeker S can start on-line dialog to transmit sound to the user terminal 101 via the same theory.

(2) Short message & Chatting:

User U can interactively chat with the job seeker S by typing. Firstly, the TSR 601 triggers the chat & short message unit 803 to build a network connection to a chat & short message unit (not shown in the figure) of the search software 123 according to the IP address of the job seeker S. Then the chat & short message unit 803 can immediately transmit the inputted works by the user U in UI 212 to the user terminal 103, and also receive the transmitted words by the chat & short message unit in the user terminal 103 and play on the UI 212 to achieve the effect of on-line contact of chatting of interactive message.

(3) Sending short messages:

Set up a network connection via the chat & short message unit 803 by the above mentioned theory. The chat & short message unit 803 can transmit the inputted message by the user U on UI 212 to the user terminal 103. It can receive the transmitted message from the user terminal 103 and display on the UI 212 as well.

(4) Video & audio talking:

User U can receive sound and image via a microphone and a digital camera of the I/O device 230 of the user terminal 101 and use the monitor and the speaker to display the image and sound of the job seeker S. Firstly, the TSR 601 triggers the AV data processing unit 805 to build a network connection to an AV data processing unit (not shown in the figure) of the search software 123 according to the IP address of the job seeker S. And the AV data processing unit 805 receives sound and image data of the user U via the microphone and the digital camera and transmits the sound and image data to the AV data compressing/decompressing unit 809 to compress and convert the AV data to network transferable data. Then the AV data compressing/decompressing unit 809 transmits the network transferable data to an AV data compressing/decompressing unit (not shown in the figure) of the search software 123 and plays the image and sound via a speaker and a monitor of the user terminal 103. By the same way, the job seeker S can start on-line AV contact to transmit image and sound to the user terminal 101 via the same theory.

(5) Email:

User U can contact the job seeker S via email. In this function, the TSR 601 will trigger the email software 208 for user U to draft an email. And then the email software 208 sends the email to a mail server 119 via the network 110. And then the user terminal 103 connects to the mail server 119 in order to receive this email. By this function, the user U can also send an email of interview request to the job seeker S in order to invite the job seeker to interview.

Further the audio data, chatting message, short message sending, AV data, and emails can be stored in the my-favorite database 201 or the found profile database 218.

Email Analyzing:

The emails for the user U to deal with are many. For example, human resource websites will regularly or irregularly transmit by email the newly user profile reports of job seekers to every member of position vacant companies. This service is very convenient for the user U. It helps to save the time of search. Human resource websites will also inform the newly information of the account for the user U. Besides, the user U can also receive job seekers' mails. Therefore the system provides the email-checking unit 260 to aid the user U to deal with emails.

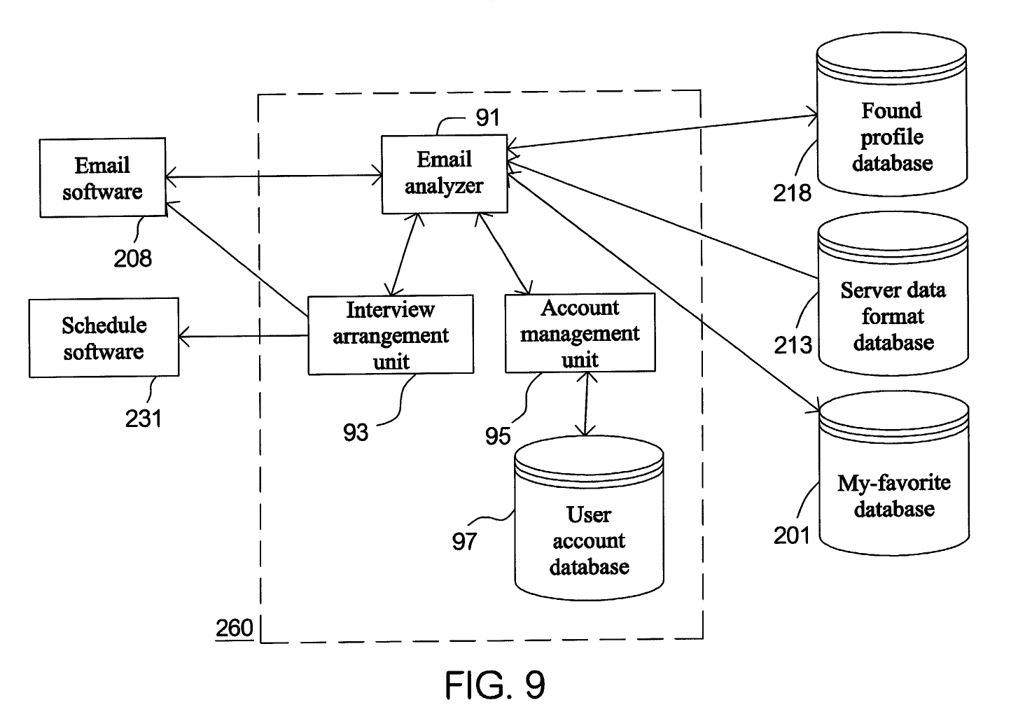

Please refer to FIG. 9. It illustrates the block diagram of the email-checking unit 260 in FIG. 2. In FIG. 9, the email-checking unit 260 comprises an email analyzer 91, an interview arrangement unit 93, an account manager 95 and user Account database 97. The email analyzer 91 is for monitoring the email software 208, checking new emails, and analyze the emails. The account manager 95 is for maintaining states of account of the user U registered in the human resource website 111 and website 113. The user account database 97 is for storing related data of accounts of the user U. And the interview arrangement unit 93 is for connecting to a schedule software 231 to arrange interview time with job seekers.

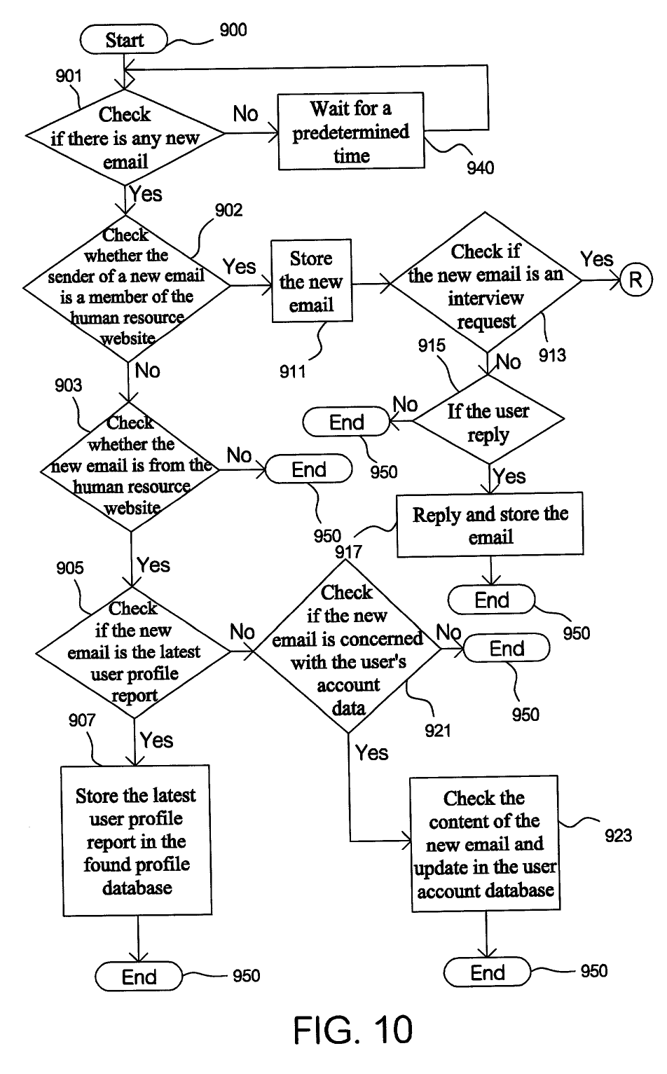

Please refer to FIG. 10. It shows the flowchart of the method for checking emails. In FIG. 10, at the step 901, the email analyzer 91 monitors the email software 208 and checks if any new emails arrive. If yes, the method proceeds to the step 902, otherwise proceeds to a step 940.

At the step 940, the email analyzer 91 waits for a predetermined time and then proceeds to the step 901. The user U can define the predetermined time and it can be five minutes or ten minutes.

At the step 902, the email analyzer 91 checks whether a sender of a new email is a member of the human resource website 111 or website 113. If yes, the method proceeds to the step 911 or else proceeds to the step 903. In this step, domain of an email address of the sender can be checked if it belongs to the human resource websites. If yes, the sender is one of the members of the human resource website.

At the step 911, the email analyzer 91 stores the new email and display the email to the user U on the UI 212. Wherein the new email can be stored in email history of the my-favorite database 201 or the found profile database 218. Next, the method proceeds to the step 913.

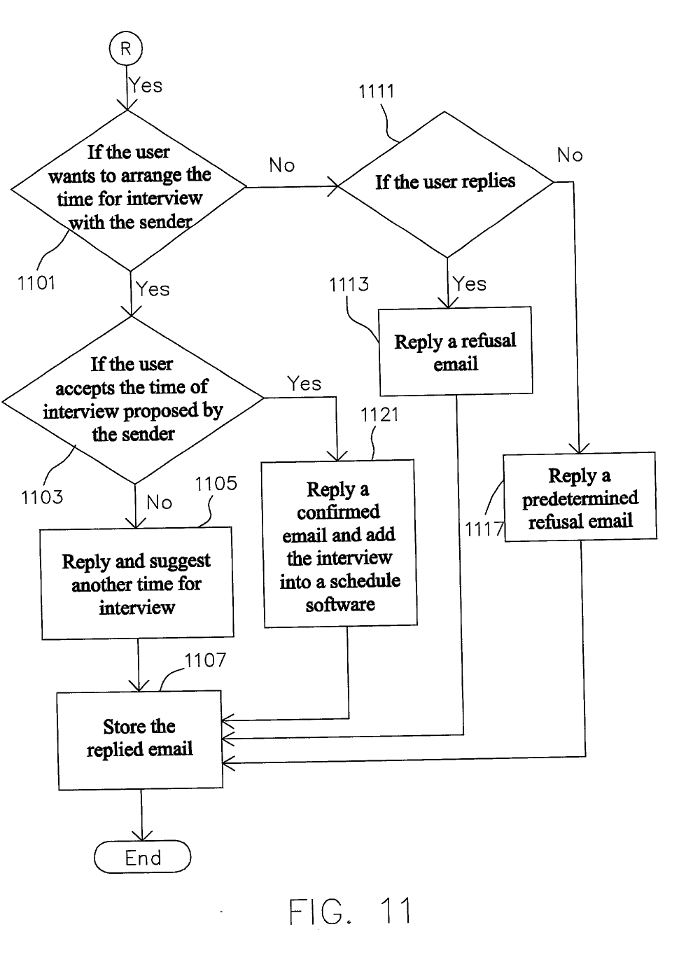

At the step 913, the email analyzer 91 analyzes the email and checks whether it is an email of interview request. If yes, the method proceeds to a node R to further proceed a method for arranging an interview. The method for arranging an appointment is shown in FIG. 11 and described later. Otherwise proceeds to the step 915.

At the step 915, the email analyzer 91 asks user U whether to reply the email. If yes, the method proceeds to the step 917. Otherwise, the method ends.

At the step 917, the email analyzer 91 can trigger the email software 208 for the user U to reply to the sender and the replied email can be stored in the my-favorite database 201 or found profile database 219.

At the step 903, the email analyzer 91 checks whether the new email is sent from human resource websites. If yes, the method proceeds to the step 905, otherwise the method ends.

At the step 905, the email analyzer 91 checks if the email is a newly user profile report sent from human resource websites. If yes, the method proceeds to the step 907. Otherwise the method proceeds to the step 921.

At the step 907, the email analyzer 91 stores the newly user profiles of the user profile report in the found profiles database 218 and display them on UI 212. Then the method ends.

At the step 921, the email analyzer 91 checks if the new mail is concerned with information of an account of user U. If yes, the method proceeds to the step 923. Otherwise it ends.

At the step 923, the email analyzer 91 triggers the account manager 95 to analyze the content of the email and to update the account data in the user Account database 97. Then the method ends.

Interview Arranging:

This system can offer the user U to arrange interview time by the method of emails, and it can also automatically add the interview time into the schedule software 213 of the user terminal 101. Please refer to FIG. 11. It illustrates the flowchart of the method for arranging an interview time. This method is after the node R of FIG. 10, and suppose the sender of the new email is a job seeker S. The method begins with the step 1101. The email analyzer 91 triggers the interview arrangement unit 93 to enquiry if the user U wants to arrange the interview time with the job seeker S or not. If yes, the method proceeds to the step 1103. Otherwise it proceeds to the step 1111.

At the step 1103, the interview arrangement unit 93 asks user U whether to accept the interview time by the job seeker S or not. If yes, the method proceeds to the step 1121. Otherwise, it proceeds to the step 1105.

At the step 1105, user U replies to the job seeker S another interview time, and then the method proceeds to the step 1107. At this step, the email software 208 is triggered from the interview arrangement unit 93 in order to offer the user U to reply the job seeker S by email.

At the step 1107, the interview arrangement unit 93 stores a corresponding relied email in the email history of the job seeker S of the my-favorite database 201 or the found profile database 218. And then the method ends.

At the step 1121, the interview arrangement unit 93 triggers the email software 208 in order to offer the user U to reply a confirmed email of interview to the job seeker S. The interview arrangement unit 93 adds the interview time into the schedule software 231. Then the method proceeds to the step 1107.

At the step 1111, the interview arrangement unit 93 asks user U whether user U wants to reply the request of interview from the job seeker S. If yes, the method proceeds to the step 1113. Otherwise it proceeds to the step 1117.

At the step 1113, the interview arrangement unit 93 triggers the email software 208 in order to offer the user U to reply a refused email to the job seeker S. Then proceeds to the step 1107.

At the step 1117, the interview arrangement unit 93 replies a default refused email to the job seeker S. Then the method proceeds to the step 1107.

Browser:

Please refer to FIG. 1, FIG. 2 and FIG. 6. When the user U uses the browser 270 to connect to these human resource websites, the TSR 601 will monitor actions of the browser 270.

(1) Searching:

When the user U connects to the human resource web site 111 for searching by the browser 270, and the TSR 601 detects the action of searching, the TSR 601 will produce a pop-up window to ask the user U whether to search all human resource websites. If the answer is yes, the TSR 601 will analyze the search condition inputted by the user U through browser 270 and sends the search condition to the search poster 216. The search poster 216 can further ask user U whether to change the search condition. If the answer is yes, the search poster 216 will wait the user U to change the search condition and then begin to connect all human resource websites to proceed searching action. The search process is the same as the above described.

(2) Registration or modification of user's profile:

When the TSR 601 detects that the user U is registering or modifying his user profile on the human resource website, the TSR 601 will produce a pop-up window to ask user U whether to connect to all human resource websites as well. If the answer is yes, the TSR 601 will analyze the user profile of the user U inputted through browser 270 and send the search conditions to the profile poster 214. The profile poster 214 can further ask user U whether if the user U wants to change the personal profiles or not. If the answer is yes, the profile poster 214 will start to connect to all human resource websites to proceed the actions of registration or modification after the user U finishes modification. The process is the same as the above described.

(3) Add a new website:

When the user U finds a new human resource website which is not included in the software, user U can press the “Add a New Human resource Website” button in the software. This function is for the user to add a new website address of a new human resource website or to get the method to inform the contact person who is maintaining the system data.

In the above description of the preferred embodiment, the invention is illustrated by taking the connection to two human resource web sites (i.e. web site III, 113) as an example, but it is to be understood that the invention is not limited thereto. The connection to multiple human resource websites is also an application of the invention. Meanwhile, from the above preferred embodiment, the invention is taking the user U of the personal department of the position vacant company C as an example, But if a job seeker would like to find the job opportunity of position vacant companies, it can be applied to the same system and method of the same theory invented by this invention. It is also one of the applications of the invention.

### EXAMPLE TWO

In this example, the preferred embodiment of the system of registering and searching in multiple human resource websites in this invention is installed in a server of a computer system. But in the explanation of this example, it describes a position vacant company wants to find a suitable job seeker. Suppose U. a user, is an employee in the personal department of a position vacant company C, who is responsible for finding a suitable person via the system of this invention.

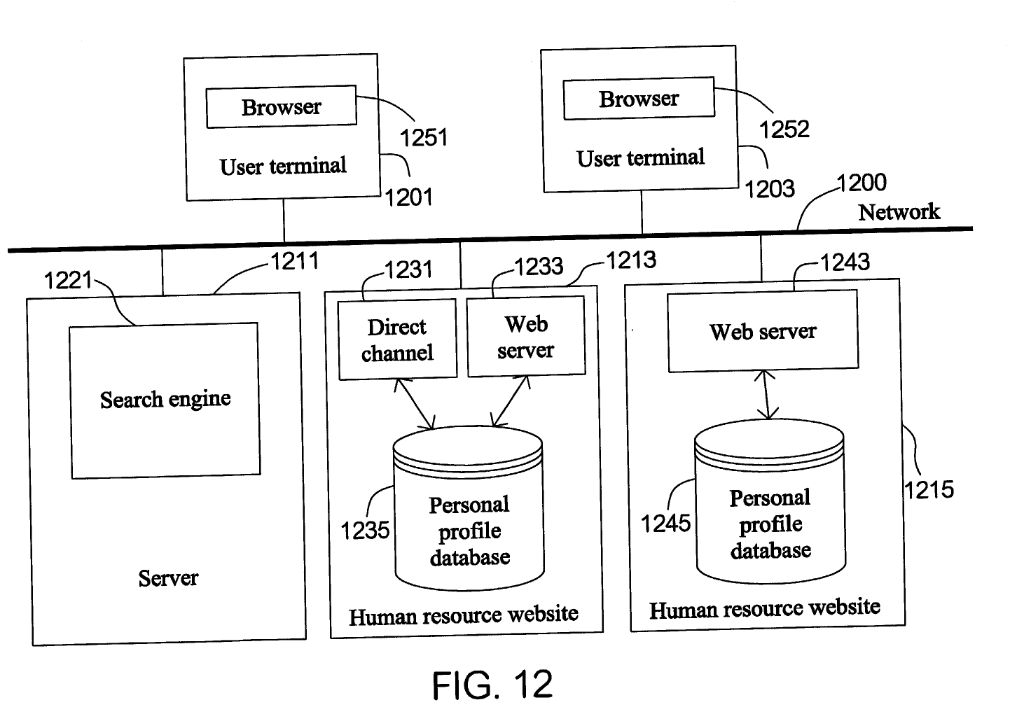

Please refer to FIG. 12. FIG. 12 shows the network computer system block diagram of the system for registering and searching in multiple human resource websites according to the example two of the preferred embodiment of the invention. In FIG. 12, a human resource website 1213 and website 1215 can offer the services of registration and search for users. The website 1213 includes a web server 1233 and a personal profile database 1235 and the website 1215 includes a web server 1243 and a personal profile database 1245. The web server 1233 and the web server 1243 are for providing users with service of registration and searching suitable job seekers. And the personal profile database 1235 and the personal profile database 1245 are for storing user profiles of companies and job seekers. The user profiles of company, including many data columns such as website account, company name, responsible name, contact name, year of company, company profile, address, contact number, email address, capital, required conditions of a newcomer, and job responsibilities an so on, can be the basic data of position vacant companies. The user profiles of job seeker, including many data columns such as website account, name, age, biography, address, contact number, email address, gender, interest, religion, education, experience, required wage, and required job position, and so on, can be the basic data of job seekers.

Besides, the website 1213 further includes a direct channel 1231. The direct channel 1231 is for providing an interface to fast access the personal profile database 1235. When the direct channel accesses to the personal profile database 1235, it does not need to convert the format of hypertext transmission protocol, HTTP. Therefore, it can offer faster access channel.

This system of the invention includes a search engine 1221, which is installed on a server 1211. The search engine 1221 is for providing users with connect, registering and searching suitable job seekers in multiple websites, such as the website 1213 and website 1215. Besides, in FIG. 12, users can use a browser 1251 in a user terminal 1201 and a browser 1251 in a user terminal 1203 to connect to the server 1211, the human resource website 1213 and website 1215 via a network 1200. Suppose a user U uses the browser 1251 of the user terminal 1201 to connect to a search engine 1221.

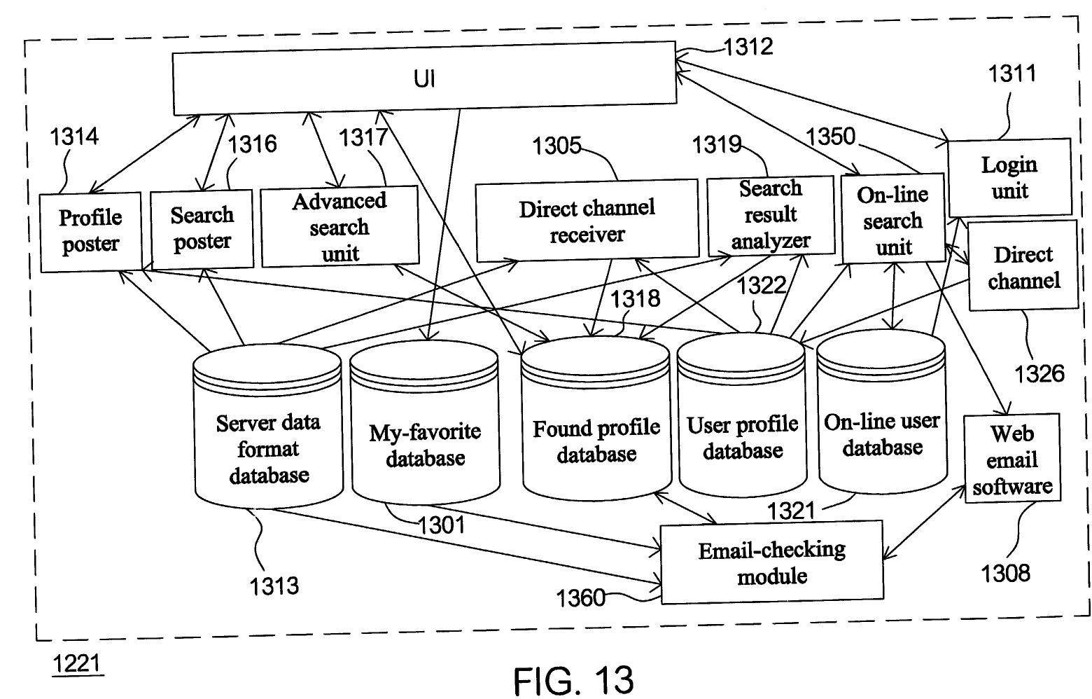

Please refer to FIG. 13. It illustrates the system block diagram of the search engine 1221. In FIG. 13, a user interface (UI) 1312 is for users to control the system. And the UI 1312 can be a graphical user interface (GUI). A profile poster 1314 is for users to transmit the user profile to the human resource website 1213 and website 1215 in order to proceed the registration or modification of user profile. A user profile database 1322 is used for storing user profiles. A search poster 1316 provides users with searching suitable job seekers in multiple human resource websites. And an advanced search unit 1317 can be used to reset search conditions for users in order to have advanced search result.

A direct channel receiver 1305 is for receive the search result transmitted from the direct channel of a human resource website (for example, the direct channel 1231 of the website 1213). And a search result analyzer 1319 is for receive the search result transmitted from the direct channel of a human resource website (for example, the direct channel 1243 of the website 1215). And the format of search results can be the hypertext markup language (HTML), extensible markup language (XML), or other languages. A found profiles database 1318 is for storing search results via the search poster 1316 or the advanced search unit 1317. A my-favorite database 1301 is for users to selectively store the user profiles of job seekers of the search results. A server data format database 1313 is for storing data format of registration and search service of multiple human resource websites. And the server data format database 1313 provides corresponding data format of every human resource website for the profile poster 1314, the search poster 1316, the direct channel receiver 1305 and the search result analyzer 1319. So, the server data format database 1313 has to be regularly updated when there sets up a new human resource website or any website changes its registration or search data format.

In addition, the search engine 1221 even includes a login unit 1311, an on-line user database 1321, an on-line search unit 1350, a direct channel 1326, an email-checking module 1360 and a web email software 1308. The on-line user database 1321 is for recording users who are on line at the same time. The login unit 1311 is for providing users to register, log-in and log-out in the search engine 1221. And wherein when users log in or log out the search engine 1221, the login unit 1311 will update the on-line user database 1321 and the user profile database 1322. The on-line search unit 1350 is for searching an on-line user from the on-line user database. The direct channel 1326 is for providing a faster connection to the on-line search unit 1350. The email-checking module 1360 is for checking a new email received by the web email software 1308.

Wherein, it is supposed that the user U uses the browser 1251 of the user terminal 1201 to connect to the search engine 1221.

Registration or Modification of User's Profile:

If user U registers to the server 1211, the login unit 1311 will request the user U to fill data columns of his user profile on the UV 1312. Therefore, this user's user profile is stored in the user profile database 1322. When user U logs in the server 1221, the user's account, name or other data will be added into the on-line user database 1321. Inversely, when user U logs out, the user's account, name or other data will be removed from the on-line user database 1321 immediately. Besides, the user U can also use the profile poster 1314 to proceed the registration or modification of user profile in the human resource website 1213. In this invention, the flowchart of the method for registering in multiple human resource websites is the same with FIG. 3. Please refer to the above description of this method.

Searching:

After user U has logged in the search engine 1221, the use U can input search conditions on UI 1312, proceed searching suitable job seekers in the human resource website 1213 and website 1215 via the search poster 1316 and restore the search result in the found profile database 1318. The flowchart of the method for searching suitable job seekers from multiple human resource websites is the same with FIG. 4. Please refer to the above description of this method.

Advanced Searching:

The user U can apply the reset of search conditions to the search result or the data in the found profile database 1318 in order to get advanced result via the advanced search unit and restore the search result in the found profile database 1318S. In the invention, the flowchart of the method for advanced searching is the same with FIG. 5. So, please refer to the above description of this method.

On-line Searching:

In FIG. 13, the system for registering and searching in multiple human resource websites even includes the on-line search unit 1350. The on-line search unit 1350 is for searching an on-line job seeker, and providing on-line contact to the on-line job seeker. There are two ways to implement on-line search.

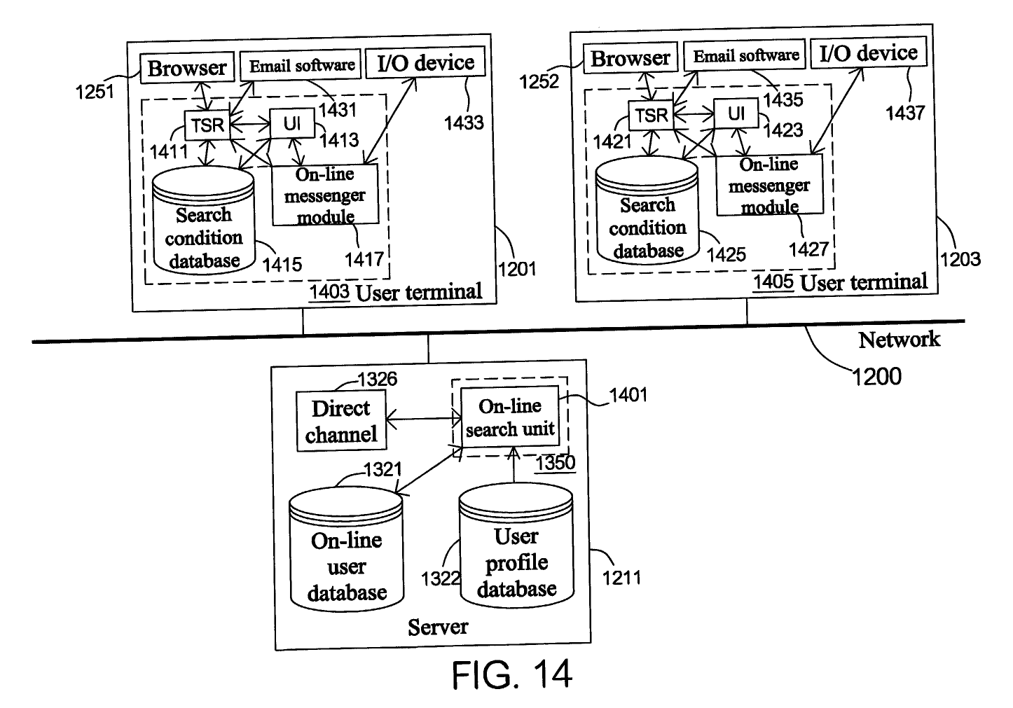

(a) Please refer to FIG. 14 at the same time, FIG. 14 shows the structural block diagram of the first on-line search method. In FIG. 14, the on-line search unit 1350 includes an on-line search unit 1401. The on-line search unit 1401 is for retrieving an on-line job seeker from the on-line user database 1321 and the user profile database 1322. Besides, the system of this invention further includes an on-line search sub module 1403, which can be installed in the user terminal 1201. The on-line search sub module 1403 is for connecting to the on-line search unit 1401 in order to search suitable on-line job seekers.

The on-line search sub module 1403 includes a terminate-and-stay-resident (TSR) 1411, UI 1413, an on-line messenger module 1417 and a search condition database 1415. The UI 1413 is for providing user U with an interface to control the on-line search sub module 1403. Therefore, UI 1413 can be a graphical user interface (GUI). The TSR 1411 is for connecting to the on-line search unit 1401 via the direct channel 1326. The TSR 1411 is a process and always resides in the operation system (OS) of the user terminal 101. The OS could be Microsoft Windows systems, OS2, Linux, Unix, and so on. The search condition database 1415 is for storing on-line search conditions. And the on-line messenger module 1417 is for building network connection with an on-line job seeker to proceed on-line contact.

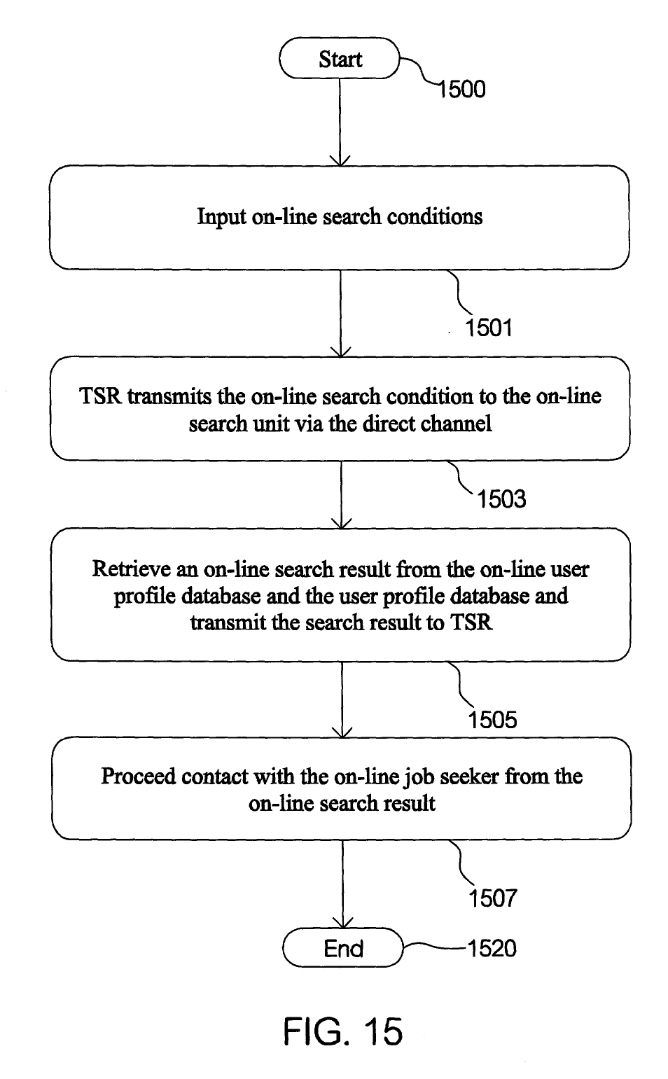

Please refer to FIG. 15 in the meantime. FIG. 15 illustrates the flowchart of the method for on-line search. Firstly, at the step 1501, user U inputs on-line search conditions for looking for an on-line job seeker who is on line at the same time. Wherein, the user U can input the on-line search conditions through the UI 1413 or the TSR 1411. Besides, the on-line search conditions can be stored in the search conditions database 1415. Next, the method proceeds to the step 1503.

At the step 1503, the TSR 1411 transmits the on-line search conditions to the on-line search unit 1401 through the direct channel 1326. And then the method proceeds to the step 1505.

At the step 1505, according to the on-line search conditions, the on-line search unit 1401 retrieves an on-line search result from the on-line user database 1321 and user profile database 1322. And the on-line search unit 1401 transmits the on-line search result to the TSR 1411 through the direct channel 1326. Wherein, an on-line result can be an on-line job seeker and the Internet protocol, IP of the computer the online job seeker is using. The on-line job seeker allows others to proceed on-line contact. The on-line search result can be displayed on UI 1413. Then, the method proceeds to the step 1507.

At the step 1507, the user U contacts the online job seeker by the on-line messenger module 1417 or an email. It is supposed that the on-line job seeker is the job seeker S. and the job seeker S is using an on-line search sub module 1405 of the user terminal 1203 to connect the server 1211.

The user U can select on-line or off-line way to contact the job seeker S. If user U chooses the way of off-line contact, the TSR 1411 will trigger an email software 1431 to serve the user U. The email software 1431 could be Microsoft Outlook, Netscape Messenger or Qualcomm Eudora . . . and so on. If the user U chooses the way of on-line contact, according to the IP address of the user terminal 1203, the on-line messenger module 1417 will build a connection to the on-line messenger module 1427. And the structural block diagram of the on-line messenger module 1417 is showed in FIG. 8. The action theory and contact way are the same as the above description.

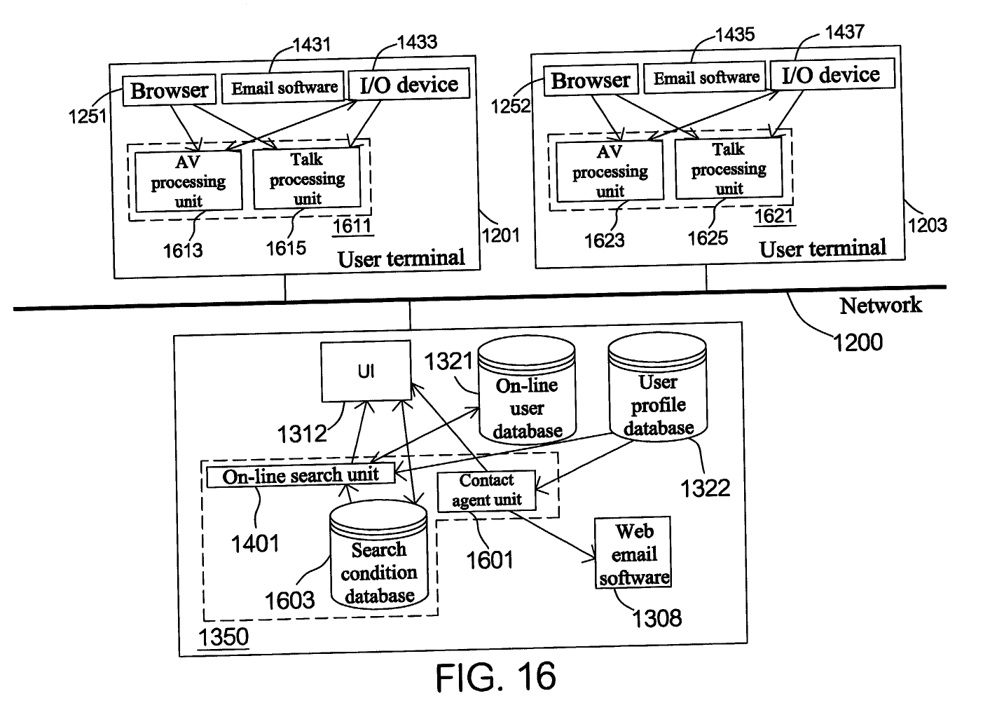

(b) Please refer the alternative way of on-line search in FIG. 16. FIG. 16 is the structural block diagram for the method of the second on-line search. In FIG. 16, the on-line search unit 1350 includes an on-line search unit 1401, a contact agent 1601 and a search condition database 1603. The on-line search unit 1401 is for retrieving an on-line job seeker from the on-line user database 1321 and the user profile database 1322. The contact agent 1601 is for retrieving an on-line job seeker's Internet protocol (IP) address or the related data that network connection needs from the user profile database 1322 such as a port. And the search condition database 1603 is for storing on-line search conditions.

Besides, the system of this invention includes an on-line contact sub module 1611, which can be installed in the user terminal 1201. The on-line contact sub module 1611 is for building a network connection to other user terminals. The on-line contact sub module 1611 includes an AV (audio and video) processing unit 1613 and a talk-processing unit 1615. The AV processing unit 1613 is for processing of converting, compressing and decompressing audio and video data. And the talk-processing unit 1615 is used for processing of converting, compressing and decompressing sound data.

At first, user U inputs on-line search conditions on the UI 1312 via a browser 1251. Then according to the on-line search conditions, the UI 1312 triggers the on-line search unit 1401 and retrieves an on-line search result from the on-line user database 1321 and the user profile database 1322. Therefore, an on-line job seeker of the on-line search result can be displayed on the UI 1312. Suppose that the on-line job seeker is job seeker S and the job seeker S is using the user terminal 1203. And an on-line contact sub module 1621 is installed on the user terminal 1203. And the user U can use the following ways to contact the job seeker S.

(1) Talking:

At first UI 1312 triggers the contact agent 1601 and retrieves the IP address that the job seeker S is using. The contact agent 1601 transmits the IP address to the talk processing unit 1615 and sends the request of message to the talking agent 1625 of the user terminal 1203 that the user U wants to talk with each other. If the job seeker S agrees, the contact agent 1601 starts to set up a network connection with the talk agent 1625. And then the user U can talk with the job seeker S each other via speakers and microphones of the I/O device 1433 and I/O device 1437. Wherein, the talk processing unit 1615 and the talk processing unit 1625 are in charge of receiving, processing, transmitting, and playing the sound data.

(2) Message chatting or sending short messages:

The user U can proceed message chatting or sending short messages with the job seeker S through the browser 1251 and a browser 1252. Firstly, the UI 1312 triggers the contact agent 1601 to display a message to the browser 1252 to remind the on-line job seeker S. Then user U and job seeker S can input messages and contact each other via the browser 1251 and the browser 1252. Wherein, the contact agent 1601 even includes a chatting and short messaging agent (not shown in the figure), which is used for implementing the above mentioned functions.

(3) AV (Audio & Video) talking:

At first, the UI 1312 triggers the contact agent 1601 to retrieve the IP (internet protocol) address that the job seeker S is using from the user profile database. The contact agent unit 1601 transmits the IP address to the AV processing unit 1613 and send the AV agent 1623 of the user terminal 1203 the request message that user U wants to have AV talking. If the job seeker S agrees, the AV processing unit 1613 and the AV processing unit 1623 build a connection with each other. And then the user U can talk with the job seeker S each other via speakers, microphones, digital cameras and monitors of the I/O device 1433 and I/O device 1437. Wherein, the AV processing unit 1615 and the AV processing unit 1625 are for receiving AV data, compress the AV data into network transferable data, transmitting to the other, receiving the data transmitted by the other, converting, decompressing and playing out.

(4) Sending an email:

User U can send the job seeker S an email as well. At first, the UI 1312 triggers the contact agent unit 1601 to retrieve an email address of the job seeker S from the user profile database 1322, transmits and displays on the browser 1251. Then the browser 1251 triggers an email software 1431 to serve user U in the user terminal 1201. Besides, the contact agent unit 1601 can trigger the web email software 1308 to serve user U in order to send emails.

Email Analyzing:

The emails for the user U to deal with are not many. For example, human resource websites will regularly or irregularly transmit by email the newly user profile reports of job seekers to every member of position vacant companies. This service is very convenient for the user U. It helps to save the time of search. Human resource web sites will also inform the newly information of the account for the user U. Besides, the user U can also receive job seekers' mails. Therefore the system provides the email-checking unit 1360 to aid the user U to deal with emails.

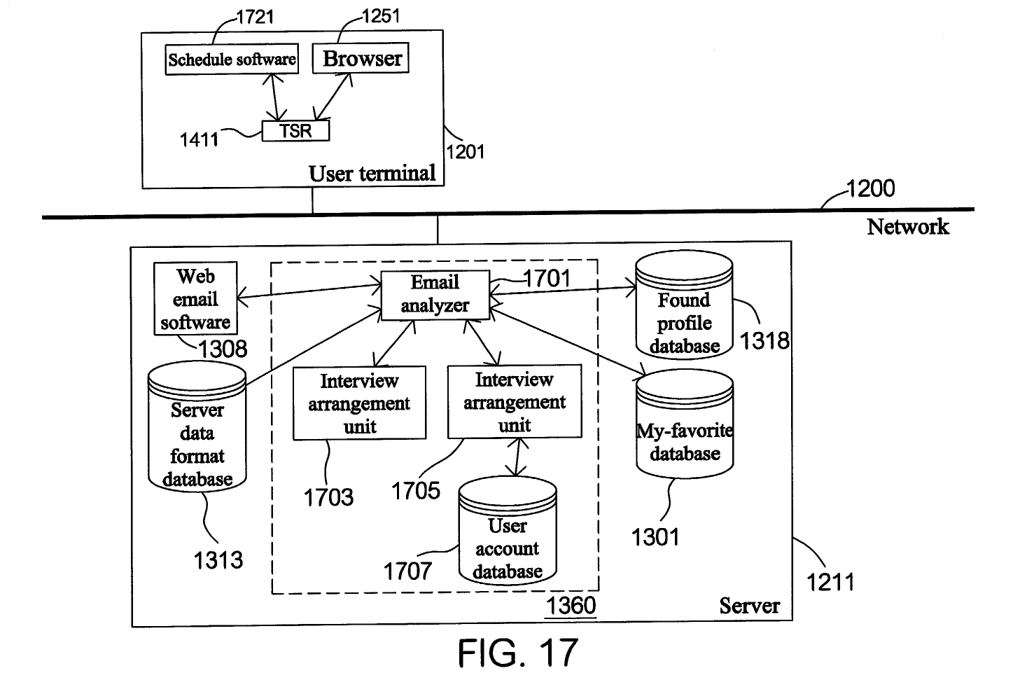

In FIG. 13, the email-checking module 1360 is used for checking new emails. Please refer FIG. 17. FIG. 17 illustrates the structural block diagram of the email-checking module 1360. In FIG. 17, the email-checking module 1360 includes an email analyzer 170 1, an interview arrangement unit 1703, an account management unit 1705 and a user account database 1707. The email analyzer 1701 is for monitoring the web email software 1308 whether receiving new emails or not, and analyzing the contents of new emails. The account management unit 1705 is for maintaining states of registration accounts of the user U in the human resource websites. The user account database 1707 is for storing related data of accounts. And the interview arrangement unit 1703 is for connecting to a schedule software 1721 of the user terminal 1201 in order to arrange interview time with job seekers.

The flowchart of the method for checking emails is shown in FIG. 10. At the step 901, the email analyzer 1701 monitors any new email received by the web email software 1308 in the server 1211. Please refer to the above mentioned description of the flowchart of the method.

Arranging Interview Time:

In this invention, the system can provide the user U to arrange an interview time by email. And the interview time can also automatically be added into a schedule software 1721. The flowchart of the method for arranging an interview time is the same with FIG. 11. But, the interview arrangement unit 1703 connects to the schedule software 1721 via the TSR 1411 of the user terminal 1201. Please refer to the above mentioned description of the flowchart of the method.

Browser:

When the user U is connecting to the human resource website 1213 by the browser 1251, the search engine 1221 may provide a function that responds to the user U's searching job seekers or updating the user profile.

(1) Searching:

When the search poster 1316 receives the user U's searching on the website 1213, the search poster 1316 will show a pop-up message on the UI 1312 to ask the user U if the user U wants to search all human resource websites. If the answer is yes, the search poster 1316 asks user U if the user U wants to change the search condition. Then the search poster 1316 will search all human resource websites recorded in the server data format database 1313. The search process is the same as the process described in the above.

(2) Registration or modification of user profile:

When the user U is registering or updating the user's own personal profile through the browser 1251 on the human resource website 1213, the profile poster 1314 will show a pop-up message on the UI 1312 to ask the user U if the user wants to register or update the user's own personal profile on all human resource websites. If the answer is yes, the profile poster 1314 will start to connect to all human resource websites to proceed the actions of registration or modification after the user U finishes modification. The process is the same as the process described in the above.

(3) Add a new website:

When the user U finds a new human resource website which is not included in the software, user U can press the “Add a New Human resource Website” button in the software. This function is for the user to add a new website address of a new human resource website or to get the method to inform the contact person who is maintaining the system data.

In the above description of the preferred embodiment, the invention is illustrated by taking the connection to two human resource websites (i.e. website 1213, 1215) as an example, but it is to be understood that the invention is not limited thereto. The connection to multiple human resource websites is also an application of the invention. Meanwhile, from the above preferred embodiment, the invention is taking the user U of the personal department of the position vacant company C as an example, But if a job seeker would like to find the job opportunity of position vacant companies, it can be applied to the same system and method of the same theory invented by this invention. It is also one of the applications of the invention.

Besides, in the above description of the preferred embodiment, the invention is illustrated by taking the user U as an example, and the system is installed in a server. It can offer multiple users to connect and search at the same time.

Besides, in the above description of the preferred embodiment, the invention is illustrated by taking user terminals (i.e. user terminal 101,103 1201, and 1203) as an example, but it is to be understood that the invention is not limited thereto. The connection of multiple human resource websites is an application of this invention. The user terminal can be any devices including but not limited to a computer, personal digital assistant (PDA), cellular phone, lined telephone, global position system (GPS) or Web television. Any human resource servers, which can offer users with searching or registering via network, are one of applications of this invention. Therefore, a human resource server can be like the human resource personal profile database 117 in FIG. 1. The personal profile database 117 does not include a web server, so it serves with different interface from HTML for connection. However the personal profile database 117 has similar functions with the human resource website 113.

In the above description of the preferred embodiment, the invention is illustrated by taking human resource websites (i.e. website 111, 113, 1213, and 1215) as an example, but it is to be understood that the invention is not limited thereto. Any is human resource host to allow a user to register or search for job seekers or position vacant companies is also an application of the invention. So a human resource host can be a personal profile database (ex. 117) and it operates without a web server and serves with different interface from HTML. However it has similar functions with human resource websites.

In the above description of the preferred embodiment, the invention is illustrated by taking that the network is regarded as a medium of connection between the system and human resource websites as an example, but it is to be understood that the invention is not limited thereto. The system can also connect to human resource hosts via a communication link. And the communication link means any channel or way of wired or wireless communication or data transmission, including but not limited to the network, wireless network, phone line, wired television line, wireless television line, or wireless with any frequency.

Effect of the Invention:

The above embodiments reveal that the invention, which is a system and method for registering or searching in multiple human resource websites, is provided with the following characteristics:

(1) Broad range for search: A user can connect and search in multiple human resource hosts.

(2) On-line contact available: When finding suitable job seekers or position vacant companies from the human resource websites, the user can immediately proceed further inquiry or arrange the time for interview if those matched ones are on-line at the same time.

(3) Less repeated process of registration: It only needs one time input of the user profile or search conditions for the user to renew or search in multiple human resource websites.

(4) Do not need to adapt to different user interfaces of the human resource websites: The user only has to be familiar with the user interface of the invention to connect to each different human resource website.

(5) The system of this invention provides the function of interview request or reply and automatically adding this arrangement into the user schedule.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A system for searching in multiple human resource hosts wherein the human resource hosts enable job seekers to search the position vacancies or the position vacant companies to search job seekers, the system comprises a first UI for a user to control the system;
a server data format database for storing the data format of search and registration of human resource hosts;
a search poster for transmitting search conditions defined by the user via the first UI to the human resource hosts with each data format of transmitting search conditions of the human resource hosts retrieved from the server data format database;
a search result analyzer for receiving and analyzing search result from the human resource hosts according to the search conditions with each data format of the human resource hosts retrieved from the server data format database; and
a found profile database for storing the search results;
wherein, after the user inputs the search conditions via the first UI, the search poster transmits the search conditions to the human resource hosts; after receiving the search conditions, the hosts retrieve the search results and then transmit the search results to the search result analyzer; and the search results are stored in the found profile database.

2. The system according to claim 1, wherein the system further comprises:
a profile poster for transmitting a user profile, which is inputted via the first UI, to the human resource hosts with each of the transmitting user profile's data format of the human resource hosts retrieved from the server data format database; and
a user profile database for storing the user profile.

3. The system according to claim 1, wherein the system further comprises an advanced search unit for users to set up further search conditions and to receive an advanced search result.

4. The system according to claim 3, wherein the system further comprises a my-favorite database for the user to selectively store the search results or the advanced results.

5. The system according to claim 1, wherein the system further comprises a my-favorite database for the user to selectively store the search results.

6. The system according to claim 1, wherein the system is installed in a user terminal.

7. The system according to claim 6, wherein the system further comprises:
a direct channel installed in a human resource host for providing a direct connection to access the personal profile database of a human resource host, to receive the search conditions from a search poster, to retrieve the search results from the personal profile database according to the search conditions, and then to transmit the search results to the user terminal; and
a direct channel receiver installed in a user terminal to receive the search results from the direct channel.

8. The system according to claim 6, wherein the system further comprises:
a direct channel installed in a human resource host for providing a direct connection to access a personal profile database of a human resource host, to receive the search conditions from a search poster, to retrieve the search results from the personal profile database according to the search conditions, and then to transmit the search results to the user terminal; and
an on-line search unit installed in the user terminal for the user to input on-line search conditions, to search an on-line matched user in the human resource host and to provide on-line contact with the on-line user, wherein the online search unit comprises:
a TSR (terminate-and-stay-resident), which is a process residing in a operation system (OS) of the user terminal and is for connecting to the personal profile database via the direct channel; and
an on-line messenger module for building on-line contact with the on-line user;
wherein, after the user inputs the on-line search conditions via the first UI; the TSR transmits the on-line search conditions to the direct channel; the direct channel retrieves an on-line search result from the personal profile database and transmits the on-line search result to the TSR; and the on-line messenger module is triggered to build the on-line contact the on-line users of the on-line search result.

9. The system according to claim 8, wherein the system further comprises a search condition database for storing the on-line search conditions.

10. The system according to claim 8, wherein the system comprises the following steps when searching the on-line users:
inputting the on-line search conditions and transmitting on-line search conditions to the human resource hosts;
retrieving the on-line search result and transmitting the on-line search result to the user terminal; and
proceeding the on-line contact with the on-line users.

11. The system according to claim 8, wherein the on-line messenger module further comprises:
an audio data compressing/decompressing unit for compressing or decompressing audio data, converting it between the audio data format and the network transferable data, and building a network connection to the on-line user; and
an audio talk unit for being triggered by a TSR to receive audio data from the microphone of a user terminal, to transmit the audio data to the audio data compressing/decompressing unit, to receive the audio data of the on-line matched user from the audio data compressing/decompressing unit and to play it via a speaker in the user terminal.

12. The system according to claim 8, wherein the on-line messenger module further comprises a chat-and-short-message unit for building a network connection to the on-line user, transmitting the inputted message from the user to the on-line user, and receiving the message from the on-line user.

13. The system according to claim 8, wherein the on-line messenger module further comprises:
an audio & video (AV) data compressing/decompressing unit for compressing and decompressing the AV data, converting the data between the AV data format and the network transferable data, and building a network connection with the on-line matched user; and
an AV data processing unit for being triggered by a TSR to receive AV data from the microphone of a user terminal and a video camera, to transmit AV data of the user to the AV data compressing/decompressing subroutine, receive AV data of the on-line user from the AV compressing/decompressing subroutine and play it via a speaker and a monitor in the user terminal.

14. The system according to claim 6, wherein the system farther comprises an email-checking module for monitoring whether the email software installed in the user terminal receives a new email and checking the new email, the email-checking module comprises:
an email analyzer for monitoring the email software and checking the new email;
an account management unit for managing the registration accounts of the users in the human resource hosts;
a user account database for storing the accounts of the human resource hosts; and
an interview arrangement unit for connecting a schedule software of the user terminal to arrange the time for interview;
wherein, when the new email checked by the email analyzer is concerned with the account of the user, the account management unit is triggered to update the user account in the user account database; and when the new email is checked by the email analyzer and is concerned with an interview request, the interview arrangement unit is triggered to arrange the request.

15. The system according claim 14, wherein the system checks the content of the new email by a method of the following steps:
a. checking if any new email arrives, proceeding step c if the new email arrives, else proceeding step b;
b. waiting a predetermined time and then proceeding the step a;
c. proceeding step d if the sender of the new email is a member of the human resource hosts, else proceeding step g;
d. storing the new email;
e. proceeding step f if the user wants to reply the new email, else ending the method;
f. replying the new email and storing the replied email and ending the method;
g. proceeding step h if the email is send by the human resource hosts, else, ending the method;
h. proceeding step i if the new email is checked to be the latest user profile report, else proceeding step j;
i. storing the latest user profile report into the found profile database and ending the method;
j. proceeding step k if the new email is concerned with the user's account, else ending the method; and
k. checking the content of the new email and updating the user account database.

16. The system according to claim 14, wherein between the step d and e further comprises:
d1. proceeding step d2 if the new email is an interview request, else proceeding step e;
d2. proceeding step d3 if the user is to arrange the time for interview with the sender, else proceeding step d7;
d3. proceeding step d6 if the user accepts the first interview proposed by the sender, else proceeding step d4;
d4. replying the sender the time for the second interview;
d5. storing a corresponding reply and ending the method;
d6. replying the sender a confirmed email, adding the first interview into a schedule software, and proceeding the step d5;
d7. proceeding step d8 if the user is to reply the sender, else proceeding step d9;
d8. replying a refusal email and proceeding the step d5; and
d9. replying a predetermined refusal email and proceeding the step d5.

17. The system according to claim 6, wherein the user terminal is a computer.

18. The system according to claim 6, wherein the user terminal is a personal digital assistant (PDA).

19. The system according to claim 6, wherein the user terminal is a cellular phone or lined telephone.

20. The system according to claim 6, wherein the user terminal is a global positioning system (GPS).

21. The system according to claim 6, wherein the user terminal is a network television.

22. The system according to claim 1, wherein the system is installed in a server and the user uses a user terminal to connect to the system.

23. The system according to claim 22, wherein the system further comprises:
a direct channel installed in a human resource host for providing a direct connection to access the personal profile database of a human resource host, to receive the search conditions from a search poster, to retrieve the search results from the personal profile database according to the search conditions, and then to transmit the search results to the user terminal; and
a direct channel receiver installed in a user terminal to receive the search results from the direct channel.

24. The system according to claim 22, wherein the system further comprises:
a login unit for providing the user to register, log in and log out;
an on-line user database for recording the on-line users;
an on-line search unit installed in the server for accessing in the on-line user database;
a direct channel for providing a direct connection to the on-line search unit; and
an on-line search sub-module installed in the user terminal for the user to input on-line search conditions, to search the on-line user from the on-line user database via the connection of the direct channel and the on-line search unit and to provide on-line contact with the on-line user, the on-line search sub-module comprises:
a second UI for the user to control the on-line search sub-module;
a TSR (terminate-and-stay-resident), which is a process residing in a operation system (OS) of the user terminal, for connecting to the on-line search unit via the direct channel; and
an on-line messenger module for building on-line contact with the on-line user;
wherein, after the user inputs the on-line search conditions via the second UI, the TSR transmits the on-line search conditions to the on-line search unit via the direct channel; the on-line search unit retrieves an on-line search result from the on-line user database and transmits the on-line search results to the TSR via the direct channel; and the on-line messenger module is triggered to build the on-line contact with the on-line user from the on-line search result.

25. The system according to claim 24, wherein the on-line search sub-module further comprises a search condition database for storing the on-line search conditions.

26. The system according to claim 24, wherein comprises the following steps when searching the on-line user:
inputting the on-line search conditions;
the TSR transmitting the on-line search conditions to the on-line search unit via the direct channel;
retrieving the on-line search result and transmitting the on-line search result to the TSR; and proceeding the on-line contact with the on-line users.

27. The system according to claim 24, wherein the on-line messenger module further comprises:
an audio data compressing/decompressing unit for compressing or decompressing audio data, converting it between the audio data format and the network transferable data, and building a network connection to the on-line user; and
an audio talk unit for being triggered by a TSR to receive audio data from the microphone of a user terminal, to transmit the audio data to the audio data compressing/decompressing unit, to receive the audio data of the on-line matched user from the audio data compressing/decompressing unit and to play it via a speaker in the user terminal.

28. The system according to claim 24, wherein the on-line messenger module further comprises a chat-and-short-message unit for building a network connection to the on-line user, transmitting the inputted message from the user to the on-line users, and receiving the message from the on-line user.

29. The system according to claim 24, wherein the on-line messenger module further comprises:
an audio & video (AV) data compressing/decompressing unit for compressing and decompressing the AV data, converting the data between the AV data format and the network transferable data, and building a network connection with the on-line matched user; and
an AV data processing unit for being triggered by a TSR to receive AV data from the microphone of a user terminal and a video camera, to transmit AV data of the user to the AV data compressing/decompressing subroutine, receive AV data of the on-line user from the AV compressing/decompressing subroutine and play it via a speaker and a monitor in the user terminal.

30. The system according to claim 22, wherein the system further comprises:
a login unit for providing the user to register, log in and log out;
an on-line user database for recording the on-line users;
an on-line search unit for retrieving an on-line user from the on-line user database and providing the on-line contact with the on-line user, the on-line search unit comprises an on-line search unit for connecting to the on-line user database to retrieve the on-line user; and a contact agent unit for retrieving an Internet Protocol (IP) address of the on-line user from the user profile database; and
an on-line contact sub-module installed in the user terminal for building on-line contact to the on-line user according the IP address;
wherein, after the user inputs the on-line search conditions via the first UI, the on-line search unit retrieves an on-line search result from the on-line user profile database, and the on-line contact sub-module is triggered to build the on-line contact with the on-line user from the on-line search result.

31. The system according to claim 30, wherein the on-line search unit further comprises a search condition database for storing the on-line search conditions.

32. The system according to claim 30, wherein the system comprises the following steps when searching the on-line users:
inputting the on-line search conditions;
retrieving the on-line search result and transmitting the on-line search result to the user terminal; and
proceeding the on-line contact with the on-line users.

33. The system according to claim 30, wherein the on-line contact sub-module further comprises a talk processing unit for building a network connection with the on-line user to transmit sound data received from the microphone of the user terminal, and to receive and play the audio data of the on-line user via the network connection.

34. The system according to claim 30, wherein the on-line contact sub-module further comprises an AV processing unit for building a network connection with the user to transmit audio and video (AV) data received from a microphone and a digital camera of the user terminal, and to receive and play AV data of the on-line user via the network connection.

35. The system according to claim 22, wherein the system further comprises:
a web email software for receiving and sending emails by the user;
a TSR (terminate-and-stay-resident), which is a process residing in a operation system (OS) of the user terminal, for connecting a scheduler software of the user terminal; and
an email-checking module for monitoring whether the email software installed in the user terminal receives a new email and checking the new email, the email-checking module comprises:
an email analyzer for monitoring the email software and analyzing the new email;
an account management unit for managing the registration accounts of the users in the human resource hosts;
a user account database for storing the accounts of the human resource hosts; and
an interview arrangement unit for connecting with a schedule software via a TSR to arrange the time for interview;
wherein, when the new email checked by the email analyzer is concerned with the account of the user, the account management unit is triggered to update the user account in the user account database; and when the new email is checked by the email analyzer and is concerned with an interview request, the interview arrangement unit is triggered to arrange the request.

36. The system according claim 35, wherein the system checks the content of the new email by a method of the following steps:
a. checking if any new email arrives, proceeding step c if the new email arrives, else proceeding step b;
b. waiting a predetermined time and then proceeding the step a;
c. proceeding step d if the sender of the new email is a member of the human resource hosts, else proceeding step g;
d. storing the new email;
e. proceeding step f if the user wants to reply the new email, else ending the method;
f. replying the new email and storing the replied email and ending the method;
g. proceeding step h if the email is sent by the human resource hosts, else, ending the method;
h. proceeding step i if the new email is checked to be the latest user profile report, else proceeding step j;
i. storing the latest user profile report into the found profile database and ending the method; and
j. proceeding step k if the new email is concerned with the user account, else ending the method;
k. checking the content of the new email and updating the user account database.

37. The system according to claim 36, wherein between the step d and e further comprises:
d1. proceeding step d2 if the new email is an interview request, else proceeding step e;
d2. proceeding step d3 if the user is to arrange the time for interview with the sender, else proceeding step d7;
d3. proceeding step d6 if the user accepts the first interview proposed by the sender, else proceeding step d4;
d4. replying the sender the time for the second interview;
d5. storing a corresponding reply and ending the method;
d6. replying the sender a confirmed email, adding the first interview into a schedule software, and proceeding the step d5;
d7. respectively proceeding step d8 or step dlO if the user is to reply the sender immediately or afterwards, else proceeding step d9;
d8. replying a refusal email and proceeding the step d5;
d9. replying a predetermined refusal email and proceeding the step d5; and
d10. suspending the interview request.

38. The system according to claim 22, wherein the user terminal is a computer.

39. The system according to claim 22, wherein the user terminal is a personal digital assistant (PDA).

40. The system according to claim 22, wherein the user termninal is a cellular phone or lined telephone.

41. The system according to claim 22, wherein the user terminal is a global positioning system (GPS).

42. The system according to claim 22, wherein the user terminal is a network television.

43. The system according to claim 1, wherein the system further comprises a function of adding new hosts, which enable the user to notify the people maintaining the data of the system about the address of a new human resource host.

44. The system according to claim 1, wherein the human resource hosts further comprise a human resource website.

45. The system according to claim 1, wherein the human resource hosts further comprise a personal profile database.

46. A system for registering in multiple human resource hosts, wherein the human resource hosts allow the job seekers or the position vacant companies to register, the system comprises:
a user interface (UI) for a user to control the system;
a server data format database for storing data format of registration of the human resource hosts;
a profile poster for transmitting a user profile inputted via the UI to the human resource hosts with each transmitting user profile data format of the human resource hosts, which is retrieved from the server data format database; and
a user profile database for storing the user profile;
wherein, after the user inputs the user profile via the UI, the profile poster saves the user profile to the user profile database, transmits the user profile to each human resource host, and then the human resource hosts receive and store the user profile.

47. The system according to claim 46, wherein the system is installed in a user terminal.

48. The system according to claim 47, wherein the user terminal is a computer.

49. The system according to claim 47, wherein the user terminal is a personal digital assistant (PDA).

50. The system according to claim 47, wherein the user terminal is a cellular phone.

51. The system according to claim 47, wherein the user terminal is a global positioning system (GPS).

52. The system according to claim 47, wherein the user terminal is a network television.

53. The system according to claim 46, wherein the system is installed in a server, and is connected to a user terminal by a user.

54. The system according to claim 53, wherein the user terminal is a computer.

55. The system according to claim 53, wherein the user terminal is a personal digital assistant (PDA).

56. The system according to claim 53, wherein the user terminal is a cellular phone or lined telephone.

57. The system according to claim 53, wherein the user terminal is a global positioning system (GPS).

58. The system according to claim 53, wherein the user terminal is a network television.

59. The system according to claim 46, wherein the human resource hosts further comprise a human resource website.

60. The system according to claim 46, wherein the human resource hosts further comprise a personal profile database.

61. The system according to claim 46, wherein the system further comprises a function of adding new hosts, which enable the user to notify the people maintaining the data of the system about the address of a new human resource host.

62. A method for registering in multiple human resource hosts by being installed in a computer to access a user profile, the method comprises:
a. inputting or modifying the user profile in the computer;
b. storing the user profile into a user profile database of the computer; and
c. posting the user profile to the human resource hosts with each of the human resource hosts' data format retrieved from a server data format database in the computer.

63. The method according to claim 62, wherein the method further comprises the following step:
d. storing or updating the user profile by the human resource hosts;
wherein some of the human resource hosts respectively comprise a direct channel for receiving the user profile and accessing a corresponding personal profile database.

64. The method according to claim 62, wherein the computer is a user terminal.

65. The method according to claim 62, wherein the computer is a server.

66. A method for searching in multiple human resource hosts via a computer, wherein the computer comprises a user interface (UT) to access a search condition, the method comprises the steps of:
a. inputting the search conditions on the UI;
b. transmitting the search conditions to the each human resource host with each of the hosts' data format of the transmitting search condition retrieved from a server data format database in the computer;
c. retrieving a search result from the human resource hosts according to the search conditions and transmitting the search results to the computer; and
d. storing the search results in the found profile database of the computer.

67. The method according to claim 66, wherein the method further comprises the following steps:
e. inputting an advanced search condition on the UI;
f. retrieving an advanced search result from the search results according to the advanced search condition; and
g. storing the advanced result to the found profile database and displaying the advanced result on the UI.

68. The method according to claim 66, wherein the computer is a user terminal.

69. The method according to claim 66, wherein the computer is a server.

70. A system of allowing multi-users to connect to search human resource, wherein a user uses a user terminal to connect the system, the system comprising:
a login unit for providing the user to register, log in and log out;
a user profile database for storing data of all registered users and recording on-line users who login in the system presently;
a user interface (UI) allowing the user to control the system and to input a search condition or an on-line search condition;
an search unit for retrieving a search result or an on-line user from the user profile database according to the search condition or the on-line search condition; and
an on-line messenger module installed in the user terminal for building on-line contact with the online user.

71. The system according to claim 70, wherein the system further comprises a search condition database for storing the search condition and the on-line search condition.

72. The system according to claim 70, wherein the system further comprises an email software allowing the user to contact with the user of the search condition or the on-line user by email.

73. The system according to claim 70, wherein the on-line messenger module further comprises:
an audio data compressing/decompressing unit for compressing or decompressing audio data, converting it between the audio data format and the network transferable data, and building a network connection to the on-line user; and
an audio talk unit for being triggered by a TSR to receive audio data from the microphone of a user terminal, to transmit the audio data to the audio data compressing/decompressing unit, to receive the audio data of the on-line matched user from the audio data compressing/decompressing unit and to play it via a speaker in the user terminal.

74. The system according to claim 70, wherein the on-line messenger module further comprises a chat-and-short-message unit for building a network connection to the on-line user, transmitting the inputted message from the user to the on-line users, and receiving the message from the on-line user.

75. The system according to claim 70, wherein the on-line messenger module further comprises:
an audio & video (AV) data compressing/decompressing unit for compressing and decompressing the AV data, converting the data between the AV data format and the network transferable data, and building a network connection with the on-line matched user; and
an AV data processing unit for being triggered by a TSR to receive AV data from the microphone of a user terminal and a video camera, to transmit AV data of the user to the AV data compressing/decompressing subroutine, receive AV data of the on-line user from the AV compressing/decompressing subroutine and play it via a speaker and a monitor in the user terminal.

76. The system according to claim 70, wherein the user terminal is a computer.

77. The system according to claim 70, wherein the user terminal is a personal digital assistant (PDA).

78. The system according to claim 70, wherein the user terminal is a cellular phone or lined telephone.

79. The system according to claim 70, wherein the user terminal is a global positioning system (GPS).

80. The system according to claim 70, wherein the user terminal is a network television.
